(19) United States
(12) Patent Application Publication
(10) Pub. No.: US 2021/0272137 A1
(43) Pub. Date: Sep. 2, 2021

(54) Apparatus for Fast Clustering of Massive Data Based on Variate-Specific Population Strata

(71) Applicant: AFFINIO INC., Halifax (CA)

(72) Inventors: Stephen James Frederic HANKINSON, Hammonds Plains (CA); Maged E. BESHAI, Maberly (CA)

(21) Appl. No.: 17/139,952

(22) Filed: Dec. 31, 2020

Related U.S. Application Data
(60) Provisional application No. 62/955,521, filed on Dec. 31, 2019.

(51) Int. Cl. G06Q 30/02; G06F 16/22; G06F 16/28; G06F 16/2457; G06F 17/16; G06F 17/18

(52) U.S. Cl. CPC G06Q 30/0201; G06F 16/2237; G06F 16/285; G06Q 30/0202; G06F 17/16; G06F 17/18; G06F 16/24578

(57) ABSTRACT

An apparatus for fast clustering of massive data is disclosed. A set of variates characterizes a population of objects with the domain of each variate segmented into a variate-specific number of population strata. The set of variates and the variate-specific population strata define boundaries of a number of cluster zones. Each object of the population of objects is allocated to a cluster corresponding to a respective cluster zone according to the boundaries of the cluster zones and object vectors individually characterizing the population of objects. Upon receiving a specific object vector of a model object, a specific cluster compatible with the model object is determined according to the specific object vector and the boundaries of the cluster zones.

### CROSS-REFERENCE TO RELATED APPLICATIONS

The present application claims the benefit of provisional application 62/955,521 filed Dec. 31, 2019, entitled “INFORMATION CLUSTERING BASED ON VARIATE-SPECIFIC POPULATION STRATA”, the entire content of which is incorporated herein by reference.

### FIELD OF THE INVENTION

The present invention relates to machine-aided marketing based on relating commodities of interest to respective model consumers, and segmenting a population of potential consumers into clusters of consumers where a cluster contains potential consumers of similar properties. In particular, the population of potential consumers is selected as participants of a social graph representing a large number of tracked users of social networks.

### BACKGROUND

Data clustering is a critical step in the rapidly growing art of data mining in several disciplines. The purpose of data mining is knowledge discovery and gaining inference regarding a variety of properties of objects under consideration, and making decisions accordingly. This is realized through exploring hidden information and property patterns within collected data. Applications of data mining include:
(a) improving health-care systems: disease diagnosis; disease prognosis; disease-treatment optimization; and identifying effective practices that improve health care and reduce cost;
(b) identifying patterns in complex manufacturing systems;
(c) recognizing fraud patterns to facilitate fraud detection;
(d) improving intrusion detection through anomaly detection; and
(e) intelligent-marketing and business applications.

Typically, a marketing model for a specific commodity relies on information gathered from a population of consumers. With the increasing popularity of social networks, massive data pertinent to potential consumers of commodities of interest can be acquired and analysed.

There are however several challenges pertaining to computational complexity, selection of appropriate descriptors of consumers, and selection of data segmentation criteria for achieving marketing objectives.

### SUMMARY

In accordance with an aspect, the invention provides an apparatus, for clustering a population of objects. The apparatus comprises a memory device storing computer executable instructions for execution causing a processor to:
(1) obtain identifiers of a set of variates characterizing each object of a population of objects, a number of population strata for each variate of the set of variates, and an object-characteristics vector for each object of the population of objects;
(2) generate a cluster-indicator vector according to the number of population strata;
(3) determine, for each variate, variate-strata boundaries according to a number of population strata of each variate;
(4) determine for each object: an object-strata-vector based on a respective object-characteristics vector of the object and the variate-strata boundaries; and a cluster index as a dot product of the object-strata vector and the cluster-indicator vector; and
(5) add each object to a respective cluster-membership storage area of a respective cluster corresponding to the cluster index, where the storage area is initialized as an empty storage area.

The computer executable instructions further cause the processor to communicate with members of any cluster.

The computer executable instructions further cause the processor to determine variate-specific multipliers Q₀, Q₁, . . . , Q₍ᵥ₋₁₎ using the recursion:

Q₍ᵥ₋₁₎=1,

Qⱼ=S₍ⱼ₊₁₎×Q₍ⱼ₊₁₎, for (v−1)>j≥0,
where v is a number of variates of the set of variates, v>1, Sⱼ is a number of population strata for variate j, 0≤j<v. The cluster-indicator vector, denoted Θ, is defined as Θ={Q₀, Q₁, . . . Q₍ᵥ₋₁₎}.

The computer executable instructions further cause the processor to determine for each variate a respective cumulative density function,
determine (S−1) reference cumulative-density values of (j×1.0/S), 0≤j<S, S being a respective number of population strata, and
determine the variate-strata boundaries to correspond to the reference cumulative-density values.

The computer executable instructions further cause the processor to determine stratum indices αⱼ for each variate j, 0≤j<v, of each object, based on comparing a value of each variate of the respective object-characteristics vector with the variate-strata boundaries. The object-strata vector, denoted Ωⱼ, is defined as Ωⱼ={α₀, α₁, . . . α₍ᵥ₋₁₎}.

Optionally, the computer executable instructions may cause the processor to determine a cumulative distribution function based on computed moments for a respective variate.

The computer executable instructions further cause the processor to periodically update the cumulative density functions and corresponding variate-strata boundaries.

Preferably, the processor comprises multiple processing units and the computer executable instructions cause different processing units to concurrently determine the object-strata-vector and the cluster index.

In accordance with another aspect, the invention provides a method, implemented using a hardware processor, for clustering a population of objects. The method comprises processes of:
(i) obtaining: identifiers of a set of variates characterizing each object of a population of objects; a number of population strata for each variate of the set of variates; and an object-characteristics vector for each object of the population of objects;
(ii) generating a cluster-indicator vector according to the number of population strata;
(iii) determining, for each variate, variate-strata boundaries according to a number of population strata of each variate;
(iv) determining for each object an object-strata-vector based on an object-characteristics vectors of the objects and corresponding variate-strata boundaries;
(v) determining for each object a cluster index as a dot product of the object-strata vector and the cluster-indicator vector; and
(vi) adding each object to a cluster-membership storage area of a respective cluster corresponding to the cluster index, to produce a plurality of clusters, the storage area being initialized as an empty storage area.

The method further comprises communicating with members of any cluster.

The method further comprises determining variate-specific multipliers Q₀, Q₁, . . . , Q₍ᵥ₋₁₎ using the recursion:

Q₍ᵥ₋₁₎=1,

Qⱼ=S₍ⱼ₊₁₎×Q₍ⱼ₊₁₎, for (v−1)>j≥0,
where v is a number of variates of the set of variates, v>1, and Sⱼ is a number of population strata for variate j, 0≤j<v. The cluster-indicator vector, denoted Θ, is defined as Θ={Q₀, Q₁, . . . Q₍ᵥ₋₁₎}.

The method further comprises: determining for each variate a respective cumulative density function; determining (S−1) reference cumulative-density values of (j×1.0/S), 0≤j<S, S being a respective number of population strata; and determining variate-strata boundaries to correspond to the reference cumulative-density values.

The method further comprises determining stratum indices αⱼ for each variate j, 0≤j<v, of each object, based on comparing a value of each variate of a respective object-characteristics vector with the variate-strata boundaries. The object-strata vector, denoted Ωⱼ, is defined as Ωⱼ={α₀, α₁, . . . α₍ᵥ₋₁₎}.

Optionally, the method may determine a cumulative distribution function of a variate based on computed moments for the variate.

The method further comprises: receiving an identifier of a specific commodity; determining characteristics of a model consumer for the specific commodity based on acquired marketing information; associating the specific commodity with a respective cluster according to the characteristics of the model consumer; and communicating information relevant to the specific commodity to objects of the respective cluster.

The method further comprises pruning the plurality of clusters to eliminate each cluster having a number of objects below a predefined lower bound and transferring objects of eliminated cluster to respective nearest clusters.

The method further comprises ranking variates of the set of variates and selecting the number of population strata for each variate according to the variate ranking.

Preferably, the hardware processor comprises multiple processing units and the method further comprises using different processing units to concurrently perform the processes of determining for each object an object-strata-vector and determining a cluster index.

In accordance with a further aspect, the invention provides an apparatus, for clustering a population of objects. The apparatus employs a processor and a memory device storing computer executable instructions organized into a number of modules, including:
(a) an information acquisition module for obtaining: identifiers of a set of variates characterizing each object of a population of objects; a number of population strata for each variate of the set of variates; and an object-characteristics vector for each object of the population of objects;
(b) a module for generating a cluster-indicator vector according to a respective number of population strata;
(c) a module for determining, for each variate, variate-strata boundaries according to a number of population strata of each variate;
(d) a module for determining for each object an object-strata-vector based on an object-characteristics vector and respective variate-strata boundaries;
(e) a module for determining for each object a cluster index as a dot product of the object-strata vector and the cluster-indicator vector; and
(f) a module for adding each object to a cluster-membership storage area of a respective cluster corresponding to a respective cluster index, the storage area being initialized as an empty storage area.

The apparatus further comprises: a storage medium storing marketing data relating each commodity of selected commodities to characteristics of a respective model consumer; a module for associating each commodity with a respective cluster according to the characteristics of a respective model consumer; and a module for communicating information relevant to a commodity to members of a respective cluster.

### BRIEF DESCRIPTION OF THE DRAWINGS

Embodiments of the present invention will be further described with reference to the accompanying exemplary drawings, in which:

FIG. 1 illustrates a marketing system based on model consumers for individual commodities, in accordance with an embodiment of the present invention;

FIG. 2 illustrates an underlying marketing method of the marketing system of FIG. 1, in accordance with an embodiment of the present invention;

FIG. 3 illustrates an exemplary implementation of the marketing system of FIG. 1 in the form of an organization assembly, an operating assembly, and a restructuring module;

FIG. 4 details the organization assembly and operating assembly of FIG. 3;

FIG. 5 illustrates values of a probability density function of a single variate corresponding to equispaced values of the variate;

FIG. 6 illustrates values of a probability density function of a single variate corresponding to equal population strata;

FIG. 7 illustrates cluster zones for a joint probability density function of two variates;

FIG. 8 illustrates formation of variates-strata zones corresponding to equal population proportions, in accordance with an embodiment of the present invention;

FIG. 9 illustrates equispaced variate sampling versus variate sampling corresponding to equispaced cumulative distribution values for a variate of uniform probability density function;

FIG. 10 illustrates equispaced variate sampling versus variate sampling corresponding to equispaced cumulative distribution values for a variate of moderate variance;

FIG. 11 illustrates equispaced variate sampling versus variate sampling corresponding to equispaced cumulative distribution values for a variate of low variance;

FIG. 12 illustrates determining variate samples defining boundaries of equal population segments;

FIG. 13 illustrates use of a variate-specific number of population segments for defining object clusters based on multivariate object characterization, in accordance with an embodiment of the present invention;

FIG. 14 illustrates object clusters based on equal numbers of population segments for each variate of a total of four variates, in accordance with an embodiment of the present invention;

FIG. 15 illustrates an example of object clusters based on variate-specific numbers of population segments for a total of four variates, in accordance with an embodiment of the present invention;

FIG. 16 illustrates another example of object clusters based on variate-specific numbers of population segments for a total of four variates, in accordance with an embodiment of the present invention;

FIG. 17 illustrates generation of object clusters for two-variate object characterization, in accordance with an embodiment of the present invention;

FIG. 18 illustrates a process of allocating objects to clusters based on object characteristics, in accordance with an embodiment of the present invention;

FIG. 19 illustrates a process of allocating objects to clusters, in accordance with an embodiment of the present invention;

FIG. 20 illustrates examples of allocating objects to clusters;

FIG. 21 illustrates determining cluster indices corresponding to variate-specific strata indices for a case of three-variate characterization, in accordance with an embodiment of the present invention;

FIG. 22 illustrates determining cluster indices corresponding to variate-specific strata indices for a case of four-variate characterization, in accordance with an embodiment of the present invention;

FIG. 23 illustrates an exemplary two-variate characterization of a population of objects;

FIG. 24 illustrates segmentation of the population into adjacent micro-clusters;

FIG. 25 illustrates a process of pruning micro clusters;

FIG. 26 illustrates segmenting a plurality of micro-clusters into a plurality of larger clusters;

FIG. 27 illustrates a method of populating clusters, in accordance with an embodiment of the present invention;

FIG. 28 illustrates a clustering apparatus, in accordance with an embodiment of the present invention; and

FIG. 29 illustrates a known iterative method of segmenting objects into a predefined number of clusters to be extended for application to segmenting micro-clusters into mini clusters.

### REFERENCE NUMERALS

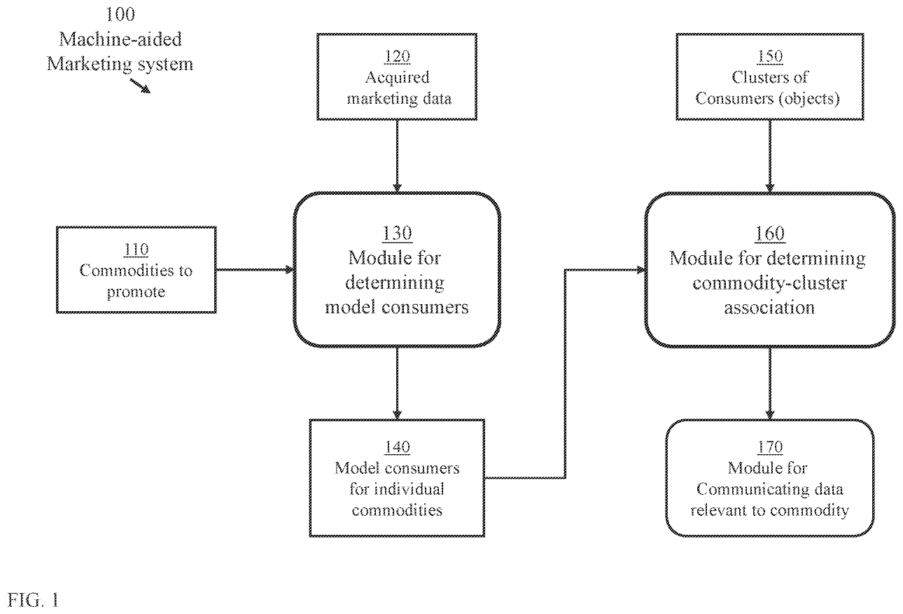

100: An overview of a machine-aided marketing system based on relating model consumers of particular commodities to clusters of prospective consumers
110: A set of commodities under consideration
120: Acquired marketing information relating individual commodities to properties of respective consumers
130: A software module for characterizing a model consumer for each commodity of the set of commodities
140: Characteristics of model consumers
150: Clusters of prospective consumers, each cluster containing consumers of common properties
160: A module for determining commodity-cluster association based on properties of model consumers and common properties of individual clusters
170: A set of target clusters for individual commodities
200: A marketing method
210: A process of receiving an identifier of a specific commodity to promote
220: A process of determining characteristics of a model consumer for a specific commodity using acquired marketing information
230: A process of segmenting a population of objects (prospective consumers) into clusters of objects based on known properties of individual objects
240: A process of determining a compatible cluster for a model consumer
250: A process of communicating with members of a compatible clusters of objects
300: An implementation of the marketing system of FIG. 1
310: A memory device storing object characterization data
320: Data-organization assembly performing segmentation of objects into clusters
340: Operational assembly implementing a marketing plans of promoting specific commodities
360: A module for periodic updating of clusters
410: Module for acquiring characteristics of objects
420: Module for segmenting a population of objects into clusters based on objects' characteristics
430: A first hardware processor
440: Data relevant to clusters of objects for use at the operating assembly 340
450: A second hardware processor
460: An interface for receiving identifiers of specific commodities to promote
470: Module for determining characteristics of a model consumer for a specific commodity
480: Module for determining a compatible cluster for a model consumer
490: Module for communicating with members of a cluster
500: Samples of a probability density function at equispaced values of the variate;
510: Selected value of the variate
520: A probability density function of the variate—preferably derived from object characterization data of a plurality of objects
600: Samples of a probability density function corresponding to equal segments of a population of objects (equal population strata)
610: Values of the variate corresponding to lower bounds of respective population strata
700: Two-variate object-cluster zones determined according to equispaced values of each variate
720: A cluster zone based on predefined variate intervals
740: Index of a cluster zone
800: Two-variate object-cluster zones determined according to equal population strata
810: Probability density function of a first variate
820: Probability density function of a second variate
830: A cluster zone based on predefined population strata
840: Index of a cluster zone
900: First example of equispaced variate sampling versus variate sampling corresponding to equispaced cumulative distribution values
910: Cumulative probability distribution of a variate of uniform probability density function
1000: Second example of equispaced variate sampling versus variate sampling corresponding to equispaced cumulative distribution values
1010: Cumulative probability distribution of a variate of moderate variance
1100: Third example of equispaced variate sampling versus variate sampling corresponding to equispaced cumulative distribution values
1110: Cumulative probability distribution of a variate of low variance
1200: Variate samples defining boundaries of equal population segments;
1210: Variate value
1220: Cumulative probability
1240: One of n strata (n=4)
1300: Variate-specific population strata
1310: Cumulative distribution of a first variate
1320: Cumulative distribution of a second variate
1330: Cumulative distribution of a third variate
1340: Cumulative distribution of a fourth variate
1400: Example of generation of object clusters based on equal numbers of population segments for each variate of four-variate object characterization
1410: Boundaries of three population strata of a first variate
1420: Boundaries of three population strata of a second variate
1430: Boundaries of three population strata of a third variate
1440: Boundaries of three population strata of a fourth variate
1500: Example of generation of object clusters based on variate-specific numbers of population segments with four-variate object characterization
1510: Boundaries of four population strata of a first variate
1520: Boundaries of three population strata of a second variate
1530: Boundaries of three population strata of a third variate
1540: Boundaries of two population strata of a fourth variate
1600: Another example of generation of object clusters based on variate-specific numbers of population segments with four-variate object characterization
1610: Boundaries of five population strata of a first variate
1620: Boundaries of four population strata of a second variate
1630: Boundaries of three population strata of a third variate
1640: Boundaries of two population strata of a fourth variate
1700: Generation of object clusters for two-variate object characterization
1710: Boundaries of four population strata of variate-A
1720: Boundaries of three population strata of variate-B
1730: Probability distribution function of variate-A
1740: Probability distribution function of variate-B
1750: Variate-A values corresponding to the four population strata
1760: Variate-B values corresponding to the three population strata
1780: Clusters defined according to variate-strata pairs
1800: Method of allocating objects to clusters based on object characteristics
1810: Preparatory processes
1820: Process of selecting variates to characterize each object of a plurality of objects
1830: Process of determining for each variate a respective number of population strata
1840: Process of determining variate-specific multipliers
1850: Operational processes
1860: Process of determining an object vector for a selected object
1870: Process of determining the object's stratum of each variate
1880: Process of determining index of a cluster to which the object belongs.
1900: Process of allocating objects to clusters
1910: Indices of strata of a first variate
1920: Indices of strata of a second variate
1930: Variate-specific strata of an object
1960: Cluster index
2000: Examples of allocating objects to clusters
2011: Values of v variates characterizing a first object, v=4;
2012: Values of v variates characterizing a second object;
2013: Values of v variates characterizing a third object;
2030: Index of a cluster to which a specific object belongs
2100: Cluster indices corresponding to variate-specific strata indices for the case of three-variate object characterization
2110: Indices of clusters
2120: Stratum index of a first variate
2121: Stratum index of a second variate
2122: Stratum index of a third variate
2200: Cluster indices corresponding to variate-specific strata indices for the case of four-variate object characterization
2210: Indices of clusters
2220: Stratum index of a first variate
2221: Stratum index of a second variate
2222: Stratum index of a third variate
2223: Stratum index of a fourth variate
2230: An object
2300: Exemplary two-variate characterization of a population of objects
2310: An object
2400: Segmentation of the population into adjacent micro-clusters
2410: Micro-cluster
2500: Micro-cluster pruning
2520: Micro-cluster of insignificant membership
2600: Segmentation of a plurality of micro-clusters into a plurality of larger clusters
2620: A cluster (normal)
2700: Method of populating clusters
2710: Stratum boundaries of a first variate
2711: Stratum indices of the first variate
2712: Stratum boundaries of a second variate
2713: Stratum indices of the second variate
2714: Stratum boundaries of a third variate
2715: Stratum indices of the third variate
2716: Stratum boundaries of a fourth variate
2717: Stratum indices of the fourth variate
2720: Cluster-indicator vector
2730: Object-strata vector of a first object
2740: Object-strata vector of a second object
2750: Object-strata vector of a third object
2800: Clustering apparatus
2810: An information acquisition module
2820: A module for generating a cumulative distribution of a variate
2830: A module for determining variate-strata boundaries
2840: A module for generating a cluster-indicator vector 0
2850: A module for acquiring object-characteristics vectors
2860: A module for generating an object-strata vector
2870: A module for associating each object with a respective cluster
2880: A module for populating the clusters
2900: Iterative method of segmenting objects into a predefined number of clusters
2920: Set of centroids
2930: Final set of centroids

### DETAILED DESCRIPTION

FIG. 1 illustrates a machine-aided marketing system 100 based on relating model consumers of particular commodities to clusters of prospective consumers.

A first storage medium 120 stores marketing data relating each commodity of a set of commodities to characteristics of a respective model consumer. A first module 130 is configured to determine for each commodity of a list of selected commodities characteristics of a respective model consumer based on the marketing data. Identifiers of the selected commodities are held in a buffer 110 and data pertinent to characteristics of respective model consumers are placed in a memory device 140.

A second storage medium 150 stores identifiers of consumers belonging to individual clusters of consumers and distinct characteristics of each said cluster of consumers. A second module 160 is configured to identify compatible clusters for each commodity of the list of commodities according to the characteristics of model consumers acquired from memory device 140 and distinct properties of individual clusters.

A third module 170 is configured to communicate information relevant to each commodity of the list of selected commodities to members of respective compatible clusters.

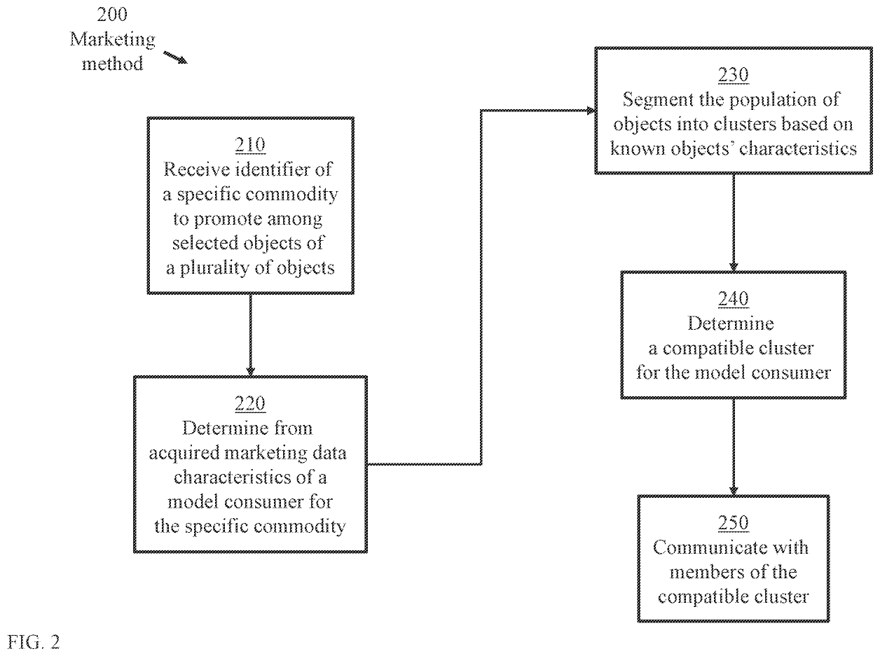

FIG. 2 illustrates an underlying marketing method 200 of the marketing system of FIG. 1. The method is implemented as processor-executable instructions causing at least one hardware processor to perform processes of:
receiving an identifier of a specific commodity to promote (process 210);
determining characteristics of a model consumer for a specific commodity using acquired marketing information (process 220);
segmenting a population of objects (prospective consumers) into clusters of objects based on known properties of individual objects (process 230);
determining a compatible cluster for a model consumer (process 240) according to the characteristics of a model consumer and said clusters of consumers; and
communicating with members of a compatible cluster of objects (process 250).

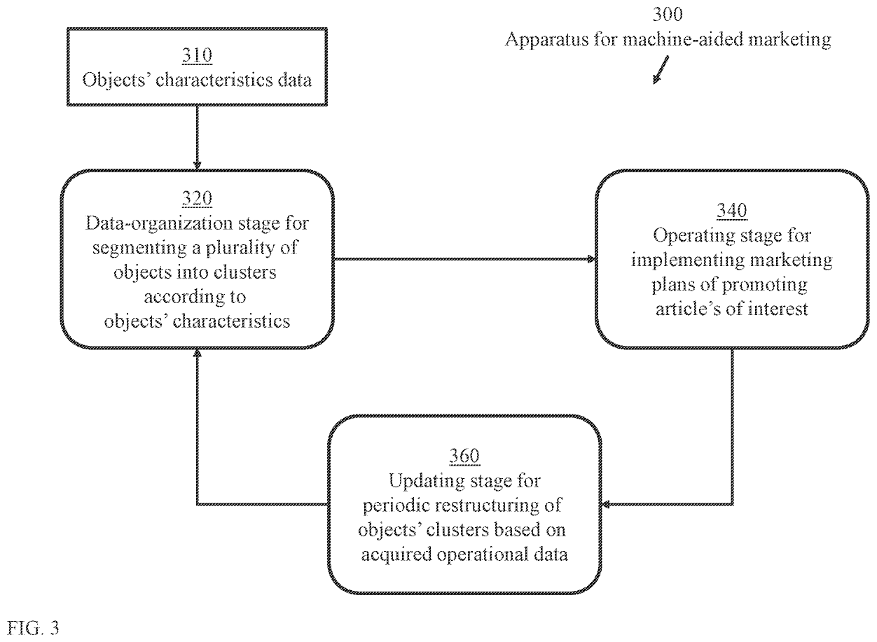

FIG. 3 illustrates an apparatus implementation 300 of the marketing system of FIG. 1. The apparatus comprises a memory device 310 storing object characterization data, a data-organization assembly 320, an operational assembly 340, and a restructuring module 360. The data-organization assembly 320 segments objects into clusters according to properties of individual objects. The operational assembly 340 implements a marketing plan of promoting specific commodities. The restructuring module 360 periodically updates the clusters according to data acquired during execution of processes of module 340.

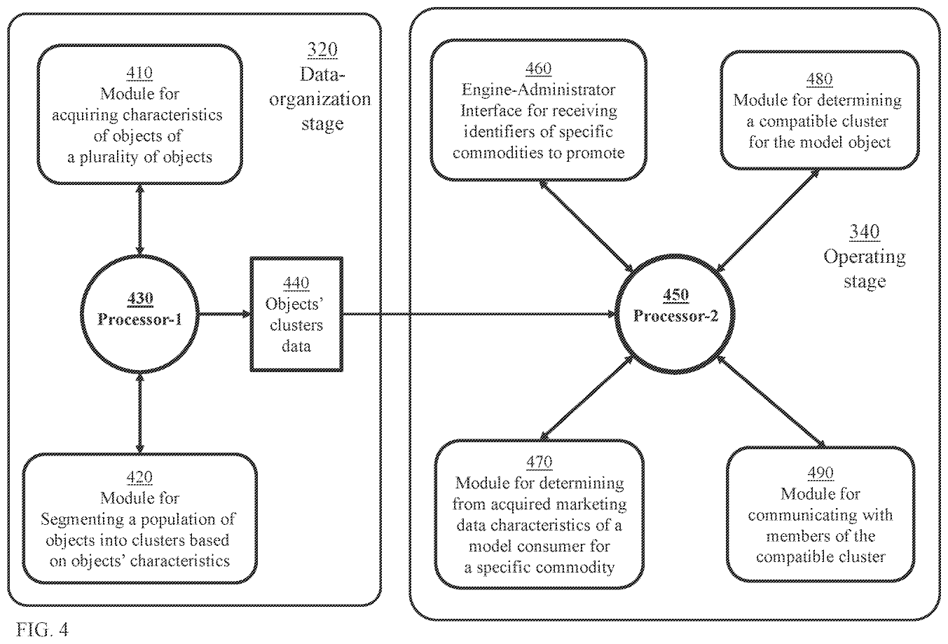

FIG. 4 details the data-organization assembly 320 and the operational assembly 340 the apparatus of FIG. 3.

The organization assembly comprises:
a first hardware processor 430
a module 410 for acquiring characteristics of objects;
a module 420 for segmenting a population of objects into clusters based on objects' characteristics; and
a memory device 440 storing data relevant to clusters of objects for use at the operating assembly 340.

The operational assembly comprises:
a second hardware processor 450;
an interface 460 for receiving identifiers of specific commodities to promote;
a module 470 for determining characteristics of a model consumer for a specific commodity;
a module 480 for determining a compatible cluster for a model consumer; and
a module 490 for communicating with members of a cluster.

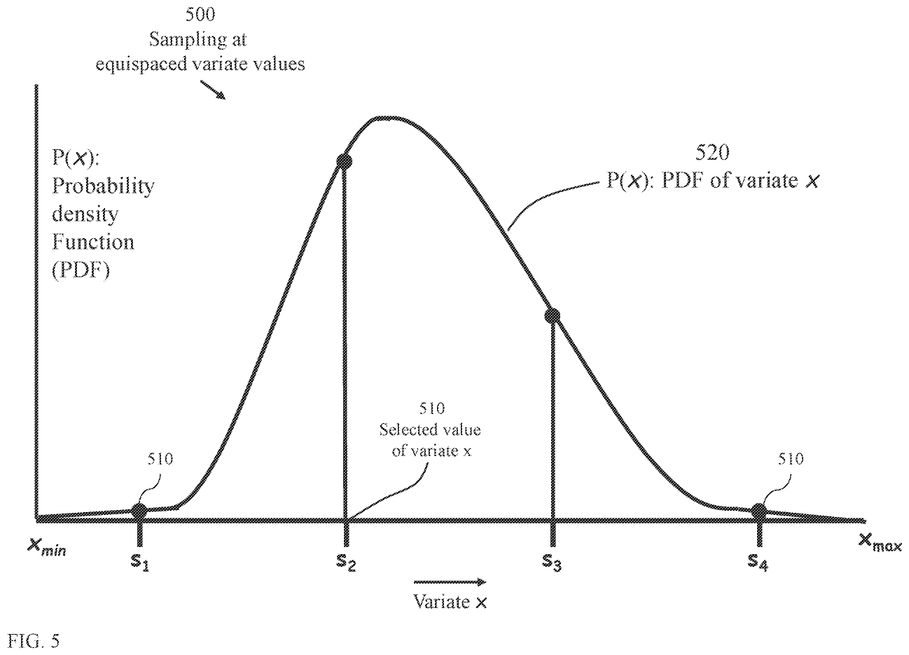

FIG. 5 illustrates samples 500 of a probability density function 520 of a single variate, denoted x, corresponding to equispaced values 510 (s₁, s₂, s₃, s₄, . . . ) of the variate. The probability density function 520 of the variate is preferably derived from object characterization data of a plurality of objects under consideration.

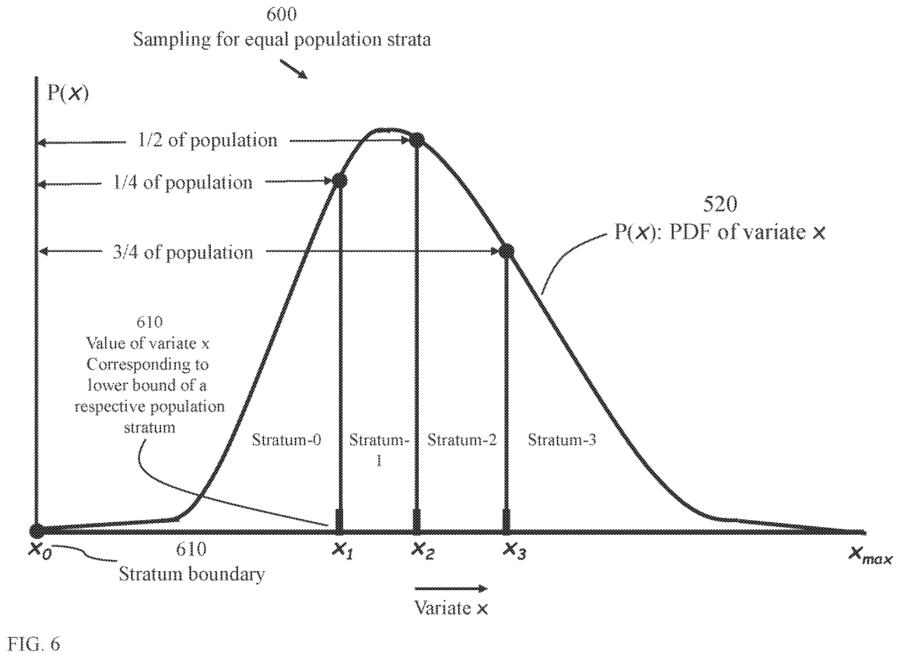

FIG. 6 illustrates samples 600 of a probability density function of a single variate corresponding to equal population strata. Values 610 denoted x₀, x₁, x₂, x₃, and xₘₐₓ of a variate denoted X define the equal population strata where the population is segmented into four equal strata. Variate values within the interval [x₀, x₁) belong to a first population stratum (stratum-0), variate values within the interval [x₁, x₂) belong to a second population stratum (stratum-1), variate values within the interval [x₂, x₃) belong to a third population stratum (stratum-2), and variate values within the interval [x₃, xₘₐₓ] belong to the fourth population stratum (stratum-3).

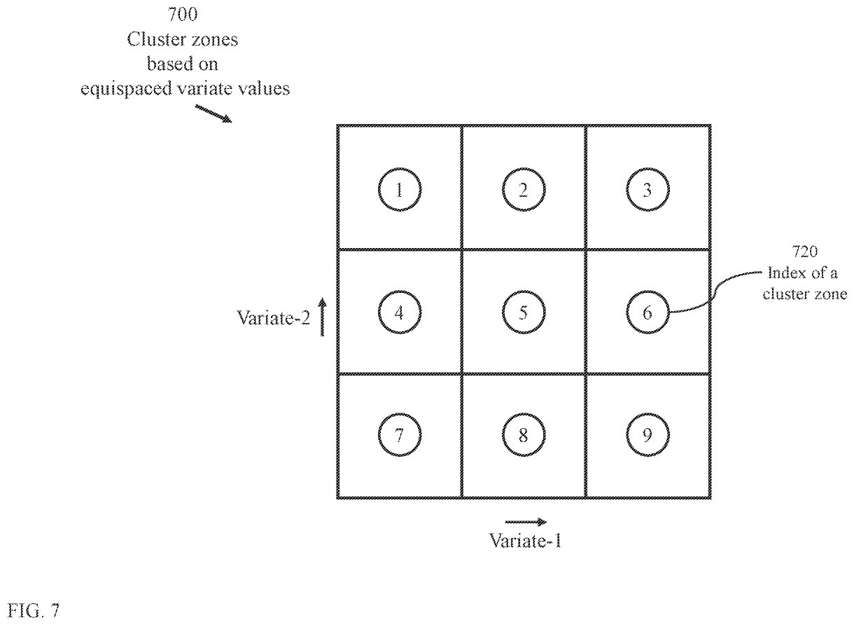

FIG. 7 illustrates formation 700 of two-variate cluster zones 720, for a joint probability density function, determined according to equispaced values of each variate. With three intervals of a first variate (variate-1) and three equal intervals of a second variate (variate-2), a total of nine cluster zones 720, indexed as 0 to 8 (reference 740), may be defined. Cluster zones 720 may contain significantly different numbers of objects depending on the shape of the probability density functions of variate-1 and variate-2.

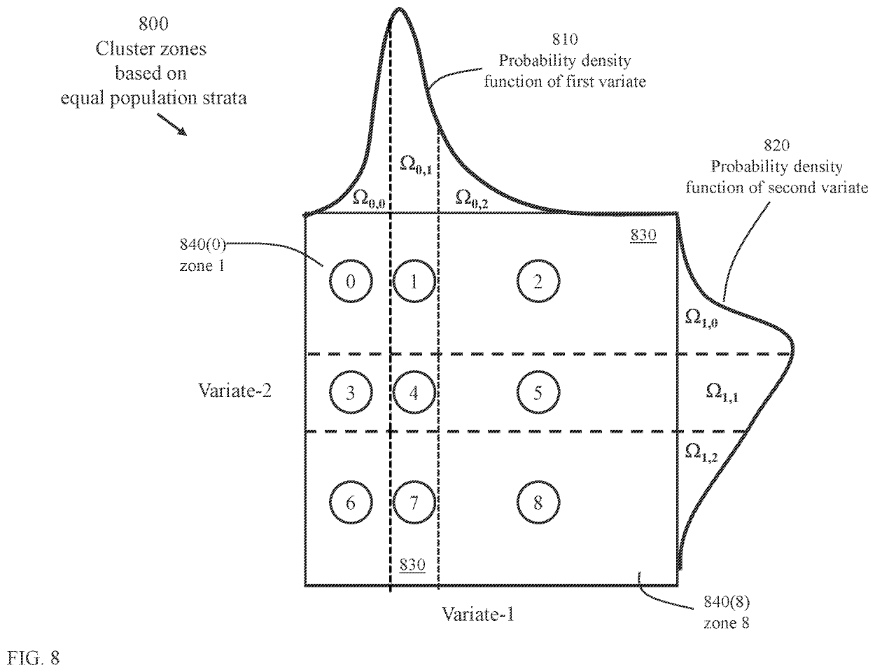

FIG. 8 illustrates formation 800 of two-variate cluster zones 830 corresponding to equal population proportions (also referenced as cluster zones of equal population-strata) determined according to a probability density function 810 of a first variate (variate-1) and a probability density function 820 of a second variate (variate-2). With three intervals of variate-1 and three equal intervals of variate-2, a total of nine cluster zones 830, indexed as 0 to 8 (reference 840), may be defined. With three equal population strata for each of variate-1 and variate-2, each cluster zone 830 may comprise objects belonging to one third of the population objects characterized by values of a respective interval of variate-1 and one third of the population characterized by values of a respective interval of variate-2. Cluster zones 830 may contain different numbers of objects.

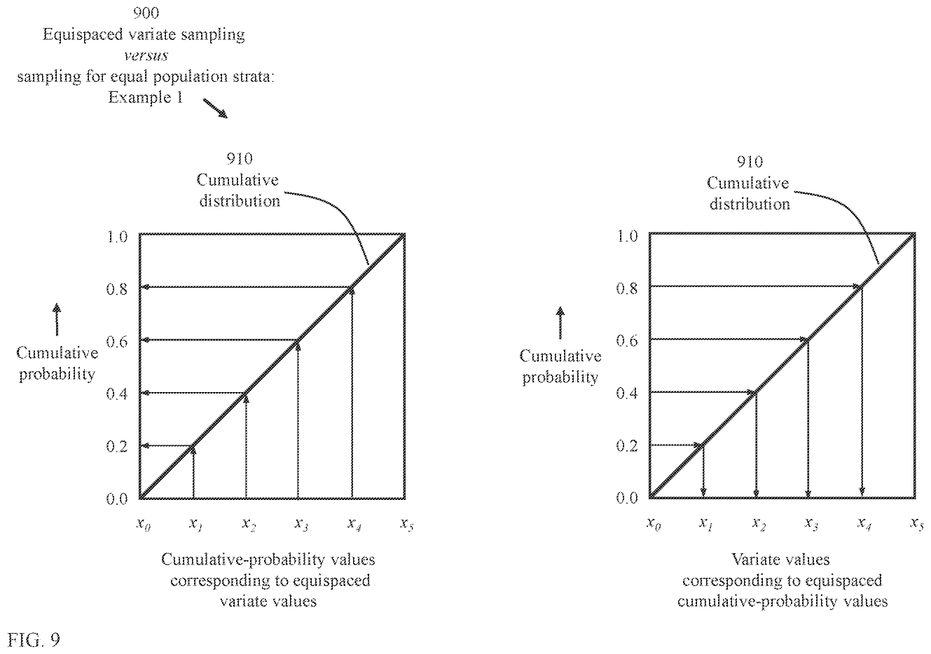

FIG. 9 illustrates a first example 900 of equispaced variate sampling versus variate sampling corresponding to equispaced cumulative distribution values for a variate of uniform probability density function. Selecting equispaced variate values x₀, x₁, x₂, x₃, x₄, and x₅ of the entire variate domain, the corresponding values of the cumulative distribution function 910 are 0.0, 0.2, 0.4, 0.6, 0.8, and 1.0. Selecting equispaced values 0.0, 0.2, 0.4, 0.6, 0.8, and 1.0 of the cumulative distribution function 910, the corresponding variate values are also equispaced: x₀, x₁, x₂, x₃, x₄, and x₅.

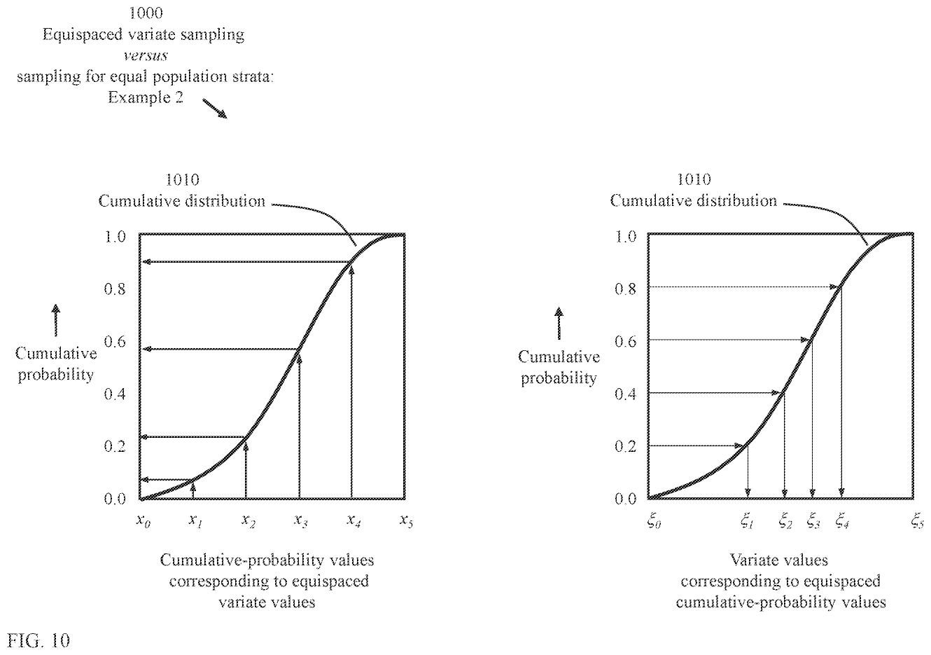

FIG. 10 illustrates a second example 1000 of equispaced variate sampling versus variate sampling corresponding to equispaced cumulative distribution values for a variate of moderate variance. The values of the cumulative distribution function 1010 for equispaced variate values x₀, x₁, x₂, x₃, x₄, and x₅ of the entire variate domain correspond to unequal segments of the population. Selecting equispaced values 0.0, 0.2, 0.4, 0.6, 0.8, and 1.0 of the cumulative distribution function, the corresponding variate values ξ₀, ξ₁, ξ₂, ξ₃, ξ₄, and ξ₅ are not equispaced.

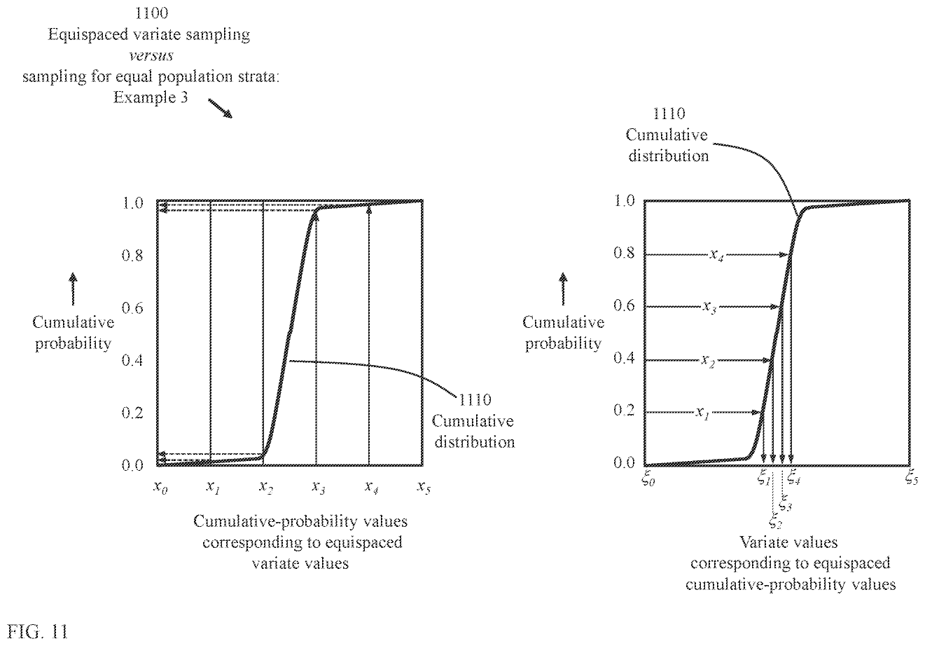

FIG. 11 illustrates a third example 1100 of equispaced variate sampling versus variate sampling corresponding to equispaced cumulative distribution values for a variate of low variance. As in the example of FIG. 10, the values of the cumulative distribution function 1110 for equispaced variate values x₀, x₁, x₂, x₃, x₄, and x₅ of the entire variate domain correspond to unequal segments of the population. Due to the low variance, hence sharp rise of the cumulative distribution function, the bulk of the objects of the population has a variate value between two successive equispaced variate values. This renders equispaced variate-value sampling inappropriate for defining cluster zones. Selecting equispaced values 0.0, 0.2, 0.4, 0.6, 0.8, and 1.0 of the cumulative distribution function, the corresponding variate values ξ₀, ξ₁, ξ₂, ξ₃, ξ₄, and ξ₅ are not equispaced and have a significant spacing variance. Selecting the variate values ξ₀, ξ₁, ξ₂, ξ₃, ξ₄, and ξ₅ to define cluster zones yields cluster zones of balanced representation of the population of objects.

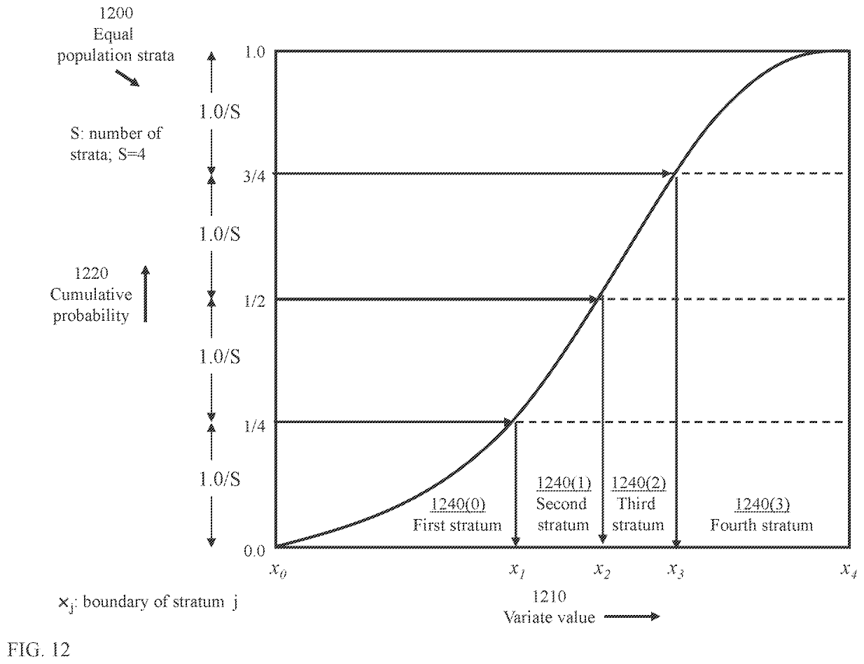

FIG. 12 illustrates an example 1200 of determining variate samples defining boundaries of equal population segments. A cumulative distribution function 1220 of a variate under consideration is determined from object characterization data (310, FIG. 3) or estimated based on moments of the variate. The population is divided into four segments of equal numbers of objects. Variate values x₀, x₁, x₂, x₃, and x₄, corresponding to cumulative-distribution-function values of 0.0, 0.25, 0.5, 0.74, and 1.0 are determined using known analytical or numerical methods to define four equal population strata 1240(0), 1240(1), 1240(2), and 1240(3).

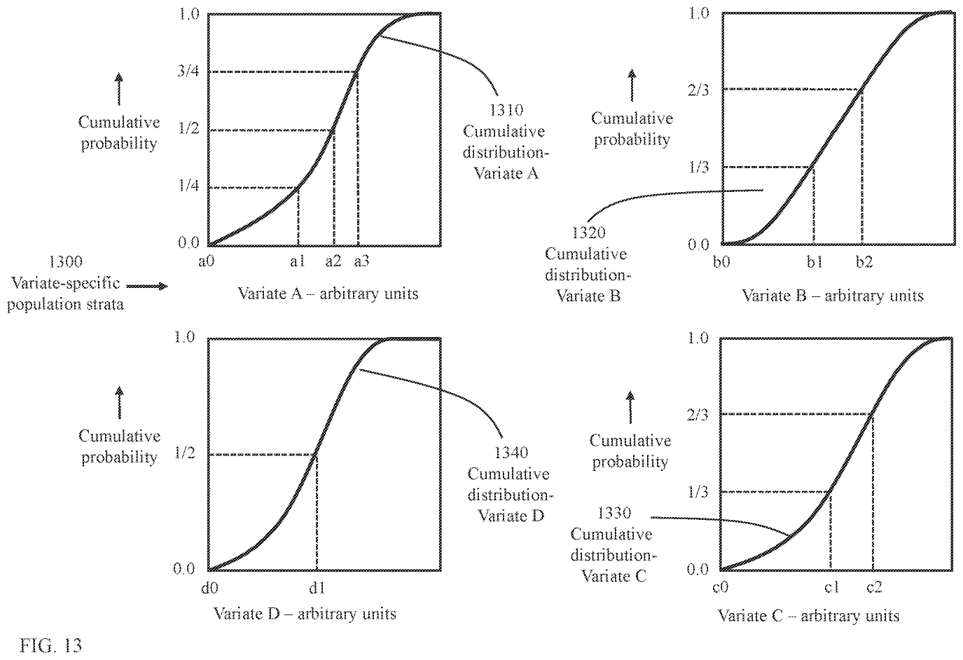

FIG. 13 illustrates an example 1300 of using a variate-specific number of population segments for defining object clusters based on multivariate object characterization. Values a₀, a₁, a₂, and a₃ of a first variate having a cumulative distribution 1310 are selected to define four equal population strata. Values b₀, b₁, and b₂ of a second variate having a cumulative distribution 1320 are selected to define three equal population strata. Values c₀, c₁, and c₂ of a third variate having a cumulative distribution 1330 are selected to define three equal population strata. Values d₀ and d₁ of a fourth variate having a cumulative distribution 1340 are selected to define two equal population strata.

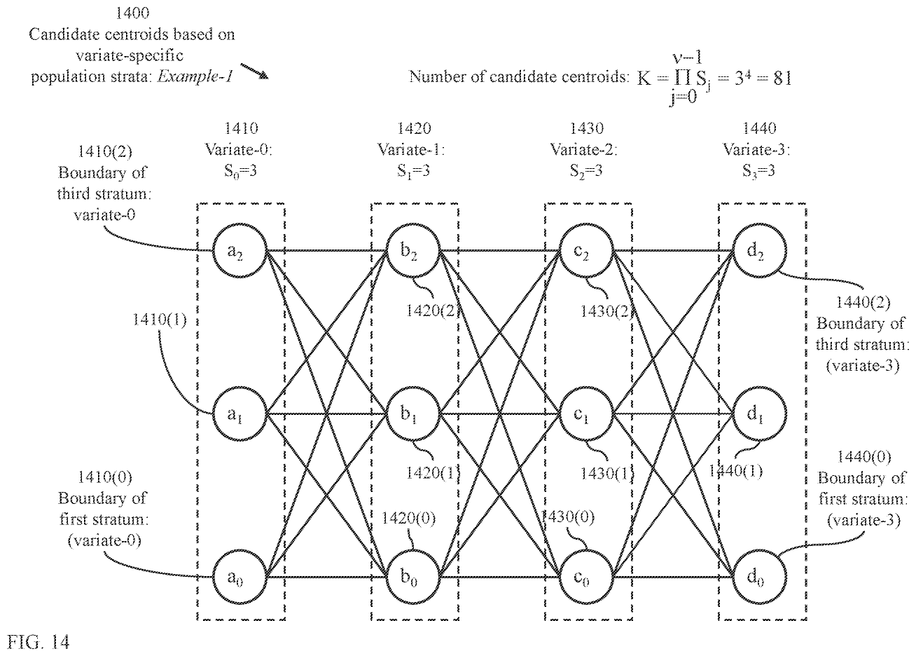

FIG. 14 illustrates an example 1400 of generation of object clusters based on equal numbers of population segments for each variate of a total of four variates characterizing a plurality of objects. Generally, with v variates, v>1, and a number of population strata Sⱼ, for a variate of index j, 0≤j<v, the total number K of cluster zones equals (S₀×S₁× . . . Sᵥ₋₁). In the illustrated example, the domain of each variate is divided into four segments so that:

values a₀, a₁, and a₂ of a first variate define boundaries 1410 of three population strata,

values b₀, b₁, and b₂ of a second variate define boundaries 1420 of three population strata,

values c₀, c₁, and c₂ of a third variate define boundaries 1430 of three population strata, and

values d₀, d₁, and d₂ of a fourth variate define boundaries 1440 of three population strata.

A combination of v boundaries, one of each of the v variates (v=4), defines a cluster zone. Thus, the combination {a₀, b₀, c₀, d₀} defines a cluster zone covering variate intervals [a₀ to a₁), [b₀ to b₁), [c₀ to c₁), and [d₀ to d₁). Likewise, the combination {a₀, b₁, c₂, d₂} defines another cluster zone. With S₀=S₁=S₂=S₃=3, the total number of cluster zones is 3^{v}=81.

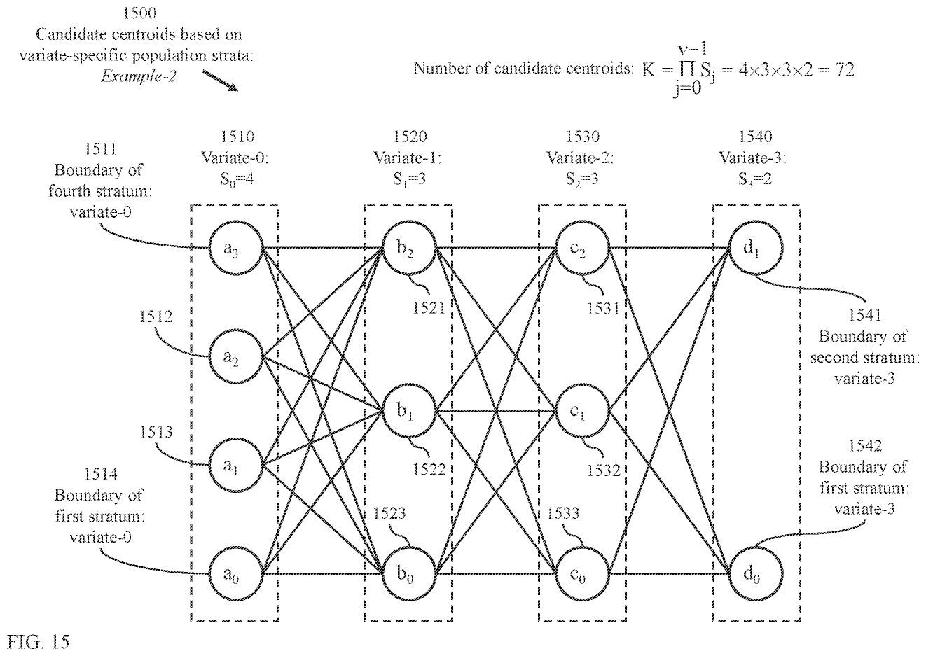

FIG. 15 illustrates an example 1500 of generation of object clusters based on equal numbers of population segments for each variate of a total of four variates (v=4) characterizing a plurality of objects. In the illustrated example:

values a₀, a₁, a₂, and a₃ of a first variate define boundaries 1510 of four population strata;

values b₀, b₁, and b₂ of a second variate define boundaries 1520 of three population strata;

values c₀, c₁, and c₂ of a third variate define boundaries 1530 of three population strata; and

values d₀ and d₁ of a fourth variate define boundaries 1540 of two population strata.

A combination of v boundaries, one of each of the v variates define a cluster zone. For example, the combination {a₂, b₀, c₂, d₁} define a cluster zone covering variate intervals [a₂ to a₃), [b₀ to b₁), [c₂ to ∞), and [d₁ to ∞). The number of population strata Sⱼ, 0≤<v, are 4, 3, 3, and 2, respectively, yielding a total number (S₀×S₁×S₂×S₃) of cluster zones of 72.

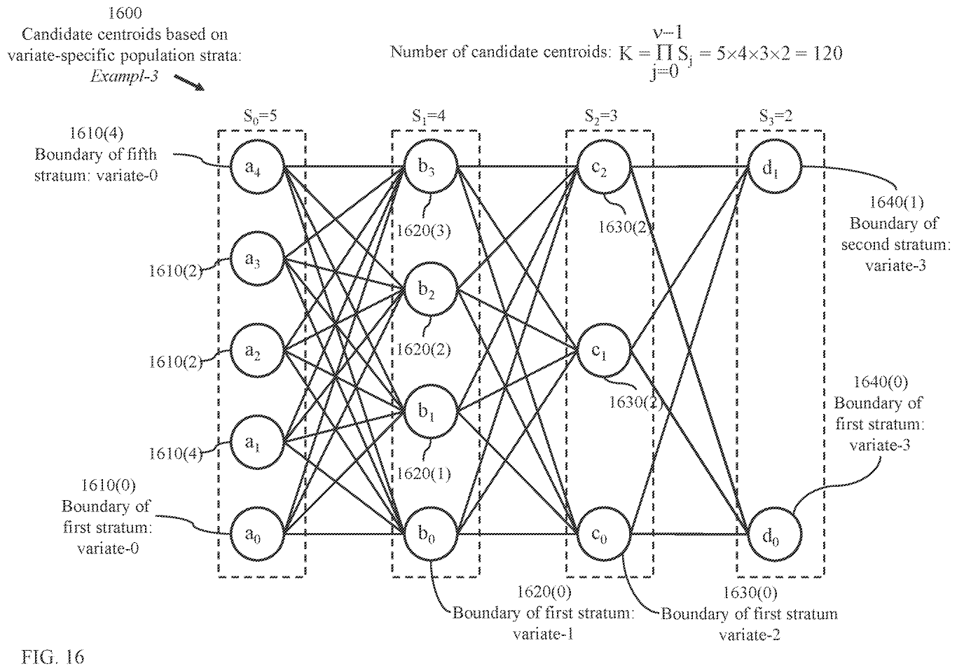

FIG. 16 illustrates an example 1600 of generation of object clusters based on equal numbers of population segments for each variate of a total of four variates (v=4) characterizing a plurality of objects. In the illustrated example:

values a₀, a₁, a₂, a₃, and a₄ of a first variate define boundaries 1610 of five population strata;

values b₀, b₁, b₂, and b₃ of a second variate define boundaries 1620 of four population strata;

values c₀, c₁, and c₂ of a third variate define boundaries 1630 of three population strata; and

values d₀ and d₁ of a fourth variate define boundaries 1640 of two population strata.

The number of population strata Sⱼ, 0≤j<v, are 5, 4, 3, and 2 yielding a total number K of cluster zones of 120.

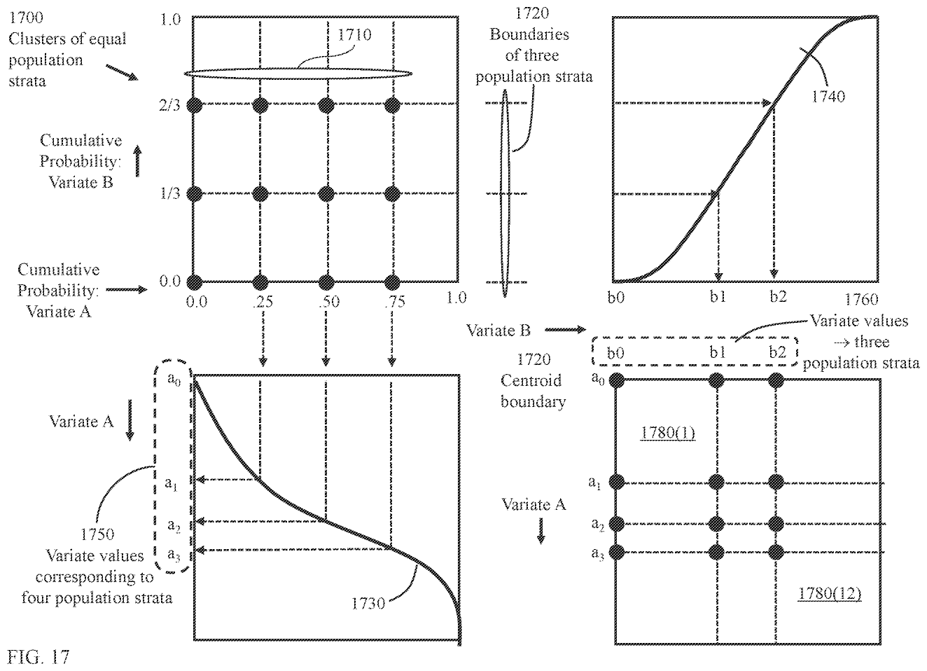

FIG. 17 illustrates a method 1700 of generating object clusters for two-variate object characterization where the domain of one variate (variate-A) is divided into four segments and the domain of the other variate (variate-B) is divided into three segments. Thus, boundaries 1710 of four population strata of variate-A are 0.0, 0.25, 0.5, and 0.75 while the boundaries 1720 of three population strata of variate-B are 0.0, 1/3, and 2/3.

The variate-A values 1750 corresponding to the four population strata are determined from the probability distribution function 1730 of variate-A as a₀, a₁, a₂, and a₃. The variate-B values 1760 corresponding to the three population strata are determined from the probability distribution function 1740 of variate-B as b₀, b₁, and b₂. Cluster zones 1780 defined according to the four variate-A domain divisions and the three variate-B domain divisions. Cluster zones 1780 are individually identified as 1780(0) to 1780(11).

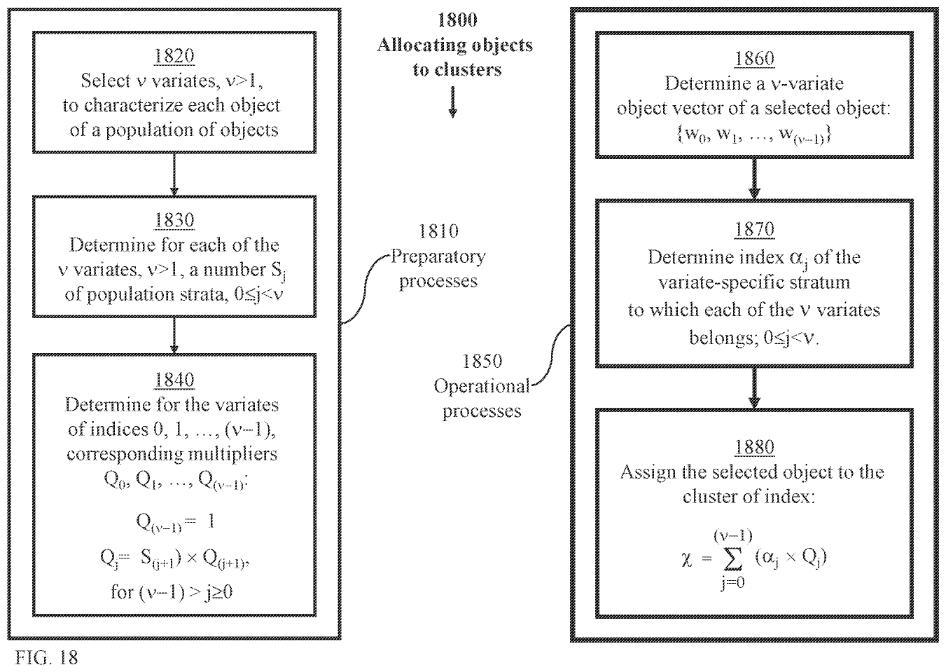

FIG. 18 illustrates a method 1800 of allocating objects to clusters based on object characteristics. To start, preparatory processes 1810 are executed for determining allocation parameters based on the number v of variates and the number Sⱼ of strata for variate j, 0≤j<v. A process 1820 selects v variates to characterize each object of a plurality of objects. A process 1830 determines for each variate a respective number of population strata. A process 1840 determines variate-specific multipliers Q₀, Q₁, . . . , Q₍ᵥ₋₁₎ using the recursion:

Q₍ᵥ₋₁₎=1, Qⱼ=S₍ⱼ₊₁₎×Q₍ⱼ₊₁₎ for (v−1)>j≥0.

The total number K of clusters is determined as (S₀×S₁ . . . ×S₍ᵥ₋₁₎). To allocate each object of a plurality of objects to a respective cluster, operational processes 1850 are executed for each object. Process 1860 determines an object vector {w₀, w₁ . . . w₍ᵥ₋₁₎} for a selected object indicating a value of each variate. Process 1870 determines the object's stratum index αⱼ for each variate j, 0≤j<v.

Referring to FIG. 16, values a₀, a₁, a₂, a₃, and a₄ of the first variate define boundaries 1610 of five population strata. A value of the first variate (variate-0) within the interval [a₀, a₁) corresponds to an object's stratum index α₀=0. A value of variate-0 within the interval [a₁, a₂) corresponds to an object's stratum index α₀=1, and so on. The table below illustrates process 1870 as applied to the clusters of FIG. 16 (four variates, v=4).

| | | | | | | Variate-3, | |
|---|---|---|---|---|---|---|---|
| Variate-0, | | Variate-1, | | Variate-2, | | S₃ = 2 | |
| S₀ = 5 | | S₁ = 4 | | S₂ = 3 | | | Stra- |
| | Stratum | | Stratum | | Stratum | | tum |
| | index | | index | | index | | index |
| Interval | α₀ | Interval | α₁ | Interval | α₂ | Interval | α₃ |
| [a₀, a₁) | 0 | [b₀, b₁) | 0 | [c₀, c₁) | 0 | [d₀, a₁) | 0 |
| [a₁, a₂) | 1 | [b₁, b₂) | 1 | [c₁, c₂) | 1 | [d₁, ∞ | 1 |
| [a₂, a₃) | 2 | [b₂, b₃) | 2 | [c₂, ∞ | 2 | | |
| [a₃, a₄) | 3 | [b₃, ∞ | 3 | | | | |
| [a₄, ∞ | 4 | | | | | | |

Q₃=1,

Q₂=S₃×Q₃=2×1

Q₁=S₂×Q₂=3×2

Q₀=S₁×Q₁=4×6

Process 1880 determines the index χ of a cluster to which the object belongs as:

χ=(α₀×Q₀×α₁×Q₁+ . . . +αᵥ₋₁×Qᵥ₋₁).

Q₍ᵥ₋₁₎=1, Qⱼ=S₍ⱼ₊₁₎×Q₍ⱼ₊₁₎ for (v−1)>j≥0.

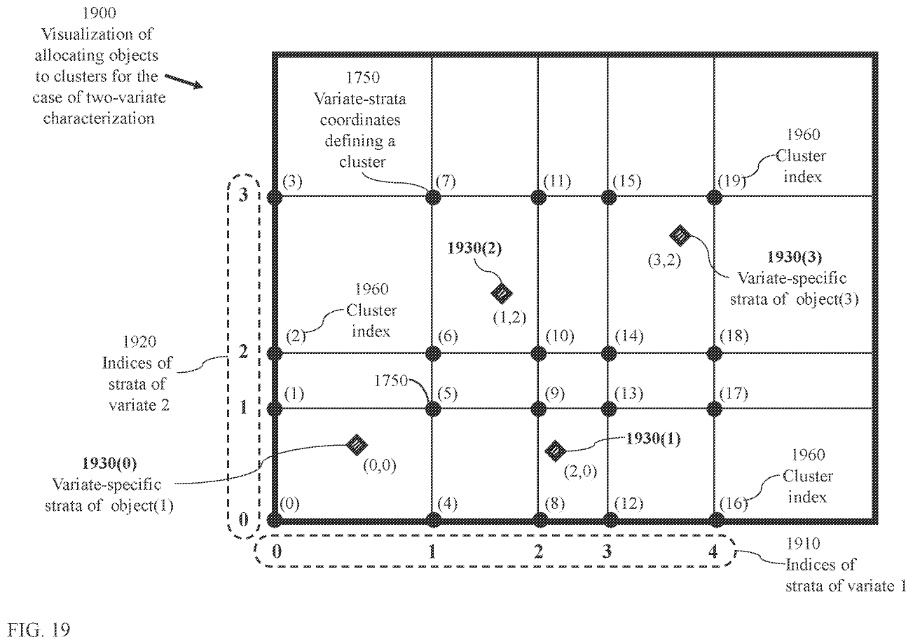

FIG. 19 illustrates a process 1900 of allocating objects to clusters for the case of two-variate characterization (v=2) with a number S₀ of strata of a first variate of 5 and a number S₁ of strata of a second variate of 4. To start, multiplier Q₍ᵥ₋₁₎, i.e. Q₁, is set to equal 1, and Q₀ is determined as S₁×Q₁=4. Variate-A values a₀, a₁, a₂, a₃ and a₄, corresponding to five population strata and variate-B values b₀, b₁, b₂ and b₃, corresponding to four population strata are determined according to the process illustrated in FIG. 17. The five strata of variate-A are indexed as 0 to 4 (reference 1910) and the four strata of variable-B are indexed as 0 to 3 (reference 1920). To allocate a cluster for an object, the variate-specific strata α₀ and α₁ (reference 1930) of the object are determined. The object is then allocated to a cluster of index χ (reference 1960) where: χ=(α₀×Q₀+α₁×Q₁), Q₀4, Q₁=1. Four objects 1930(0) to 1930(3) are considered.

The values of variate-0 and variate-1 of object 1930(0) are within the intervals [a₀, a₁} and [b₀, b₁), respectively. Hence, variate-specific strata {α₀, α₁}, are determined as α₀=α₁=0, and object 1930(0) is determined to belong to cluster χ=0.

The values of variate-0 and variate-1 of object 1930(1) are within the intervals [a₂, a₃} and [b₀, b₁), respectively. Hence, variate-specific strata {α₀, α₁}, are determined as α₀=2, α₁=0, and object 1930(1) is determined to belong to cluster χ=2×4.

The values of variate-0 and variate-1 of object 1930(2) are within the intervals [a₁, a₂} and [b₂, b₃), respectively. Hence, variate-specific strata {α₀, α₁}, are determined as α₀=1, α₁=2, and object 1930(2) is determined to belong to cluster χ=1×4+2×1=6.

The values of variate-0 and variate-1 of object 1930(3) are within the intervals [a₃, a₄} and [b₂, b₃), respectively. Hence, variate-specific strata {α₀, α₁}, are determined as α₀=3, α₁=2, and object 1930(2) is determined to belong to cluster χ=3×4+2×1=14.

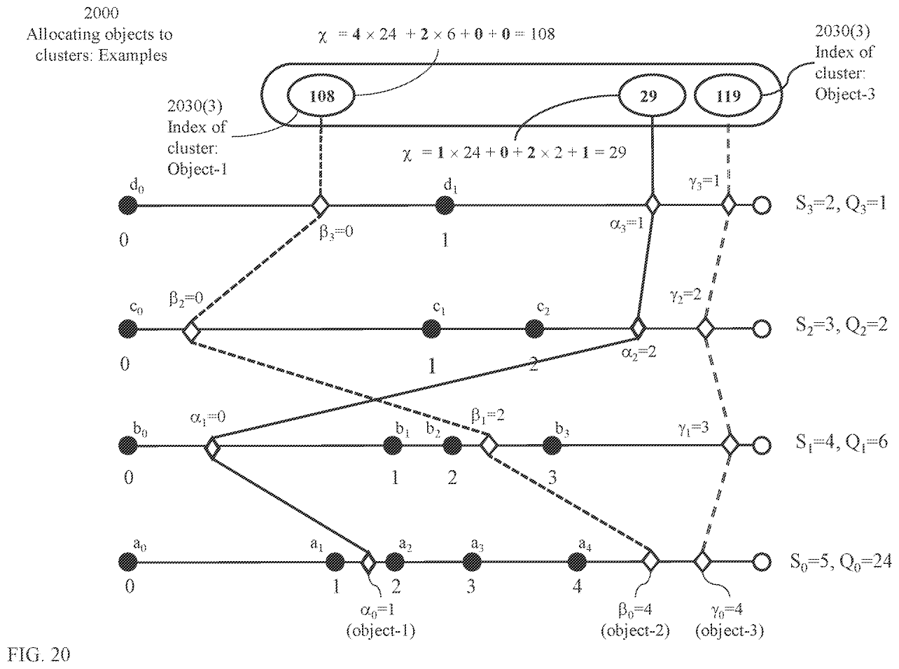

FIG. 20 illustrates examples 2000 of allocating four-variate objects (v=4) to clusters defined according to variate-specific equal population strata. The variates are indexed as 0 to 3 with S₀=5, S₁=4, S₂=3, and S₃=2, yielding a total of 120 clusters. Using the method of FIG. 18, the multipliers Q₀ to Qᵥ₋₁ are determined as Q₃=1, Q₂=S₃×Q₃=2, Q₁=S₂×Q₂=6, and Q₀=S₁×Q₁=24.

The values of the first variable corresponding to the five population strata are determined as a₀, a₁, a₂, a₃, and a₄. The values of the second variable corresponding to the four population strata are determined as b₀, b₁, b₂, and b₃. The values of the third variable corresponding to the three population strata are determined as c₀, c₁, and c₃. The values of the fourth variable corresponding to the two population strata are determined as d₁ and d₂.

Stratum indices α₀, α₁, α₂, α₃ of a first object (object-1) are determined as α₀=1, α₁=0 α₂=2, and α₃=1. Thus, object-1 is allocated to a cluster of index χ₁ determined as:

χ₁=α₀×Q₀+α₁×Q₁+α₂×Q₂+α₃×Q₃=29.

Stratum indices β₀, β₁, β₂, β₃ of a first object (object-1) are determined as β₀=4, β₁=2 β₂=0, and β₃=0. Thus, object-2 is allocated to a cluster of index χ₂ determined as:

χ₂=β₀×Q₀+β₁×Q₁+β₂×Q₂+β₃×Q₃=108.

Stratum indices γ₀, γ₁, γ₂, γ₃ of a first object (object-1) are determined as γ₀=4, γ₁=3 γ₂=2, and γ₃=1. Thus, object-1 is allocated to a cluster of index χ₁ determined as:

χ₁=γ₀×Q₀+γ₁×Q₁+γ₂×Q₂+γ₃×Q₃=119.

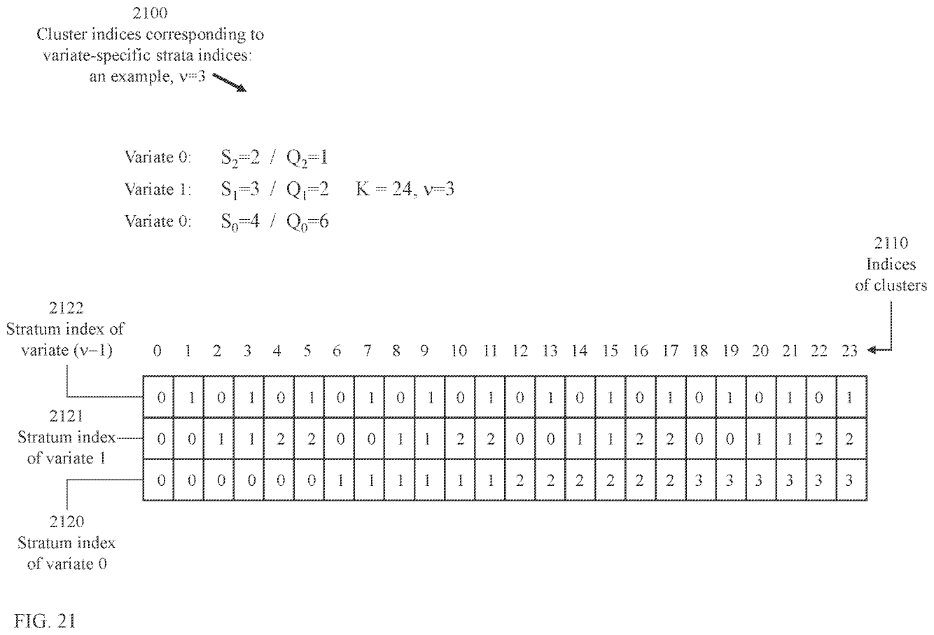

FIG. 21 is a table 2100 of all combinations of variate-specific strata indices and corresponding cluster indices for a case of three-variate object characterization (v=3). The variates are indexed as 0, 1, and 2 with the numbers of variate strata selected as S₀=4, S₁=3, and S₂=2, yielding a total of 24 clusters indexed as 0 to 23 (reference 2110). Using the method of FIG. 18, the multipliers Q₀ to Qᵥ₋₁ are determined as Q₂=1, Q₁=2, and Q₀=6. Row 2120 of the table lists strata 0, 1, 2, and 3 of variate-0. Row 2121 lists strata 0, 1, and 2 of variate-1. Row 2122 lists strata 0 and 1 of variate-2.

An object of stratum indices α₀, α₁, and α₂ is allocated to a cluster of index χ determined as:

χ=α₀×Q₀+α₁×Q₁+α₂×Q₂, where Q₀6, Q₁=2, Q₂=1.

For example, an object with strata indices α₀=2, α₁=1 and α₂=0, is allocated to the cluster of index (2×6+1×2=14). An object with strata indices α₀=3, α₁=2 and α₂=1, is allocated to the cluster of index (3×6+2×2+1×1=23).

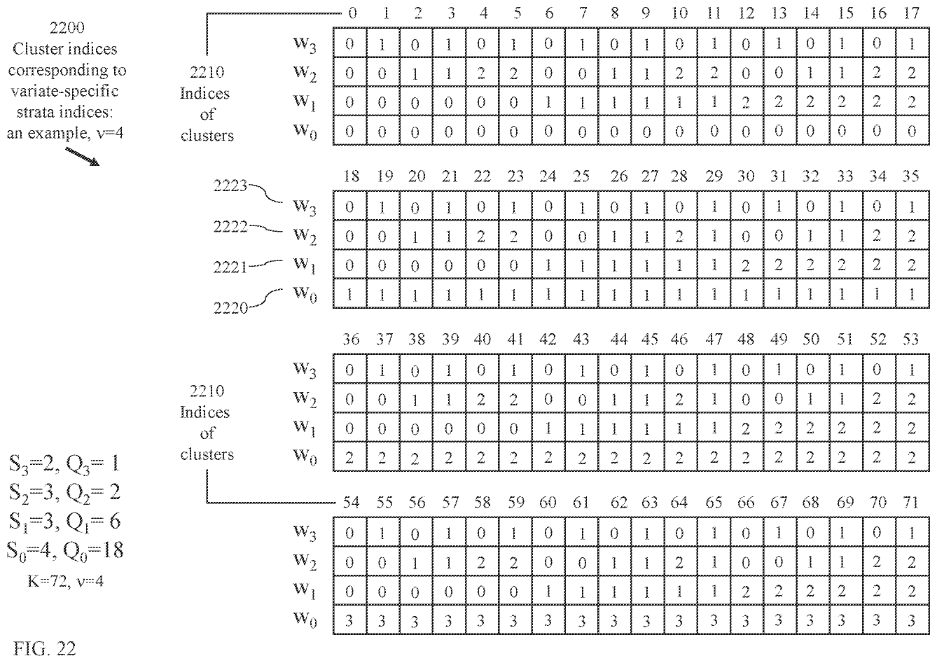

FIG. 22 is a table 2200 of all combinations of variate-specific strata indices and corresponding cluster indices for a case of four-variate object characterization (v=4). The variates are indexed as 0, 1, 2, and 3 (denoted w₀, w₁, w₂, and w₃, reference 2220, 2221, 2222, and 2223, respectively) with the numbers of variate strata selected as S₀=4, S₁=3, S₂=3, and S₃=2, yielding a total of 72 clusters indexed as 0 to 71 (reference 2210). Using the method of FIG. 18, the multipliers Q₀ to Qᵥ₋₁ are determined as Q₃=1, Q₂=2, Q₁=6, and Q₀=18. The table lists strata 0, 1, 2, and 3 of w₀, strata 0, 1, and 2 of w₁, strata 0, 1, and 2 of w₂, and strata 0 and 1 of w₃.

An object of stratum indices α₀, α₁, α₂, and α₃ is allocated to a cluster of index χ determined as:

χ=α₀×Q₀+α₁×Q₁+α₂×Q₂+α₃×Q₃.

For example, an object 2230 with strata indices α₀=1, α₁=2, α₂=2 and α₂=1, is allocated to the cluster of index (1×18+2×6+2×2+1×1), that is cluster 35.

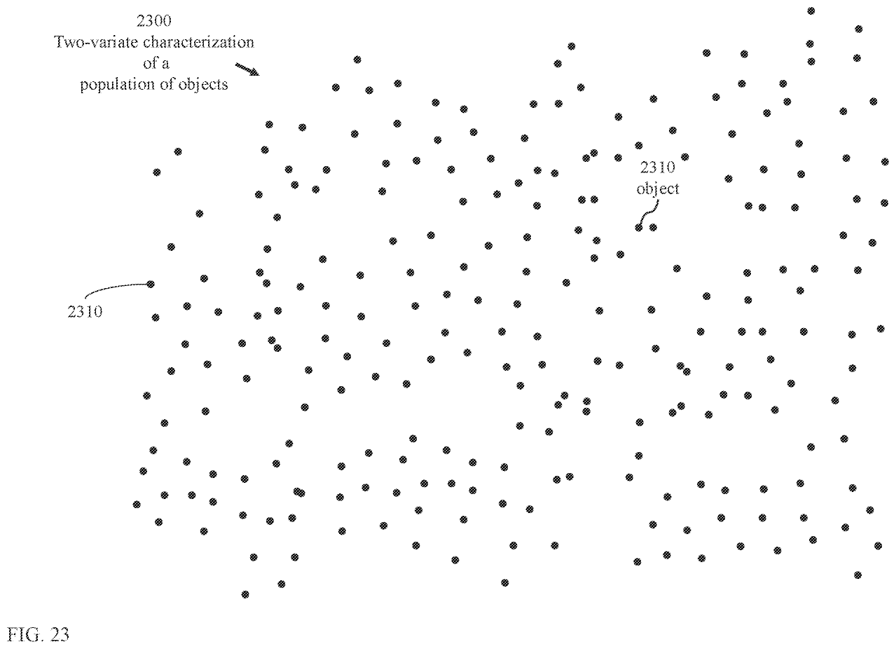

FIG. 23 illustrates an exemplary two-variate characterization 2300 of a population of objects 2310.

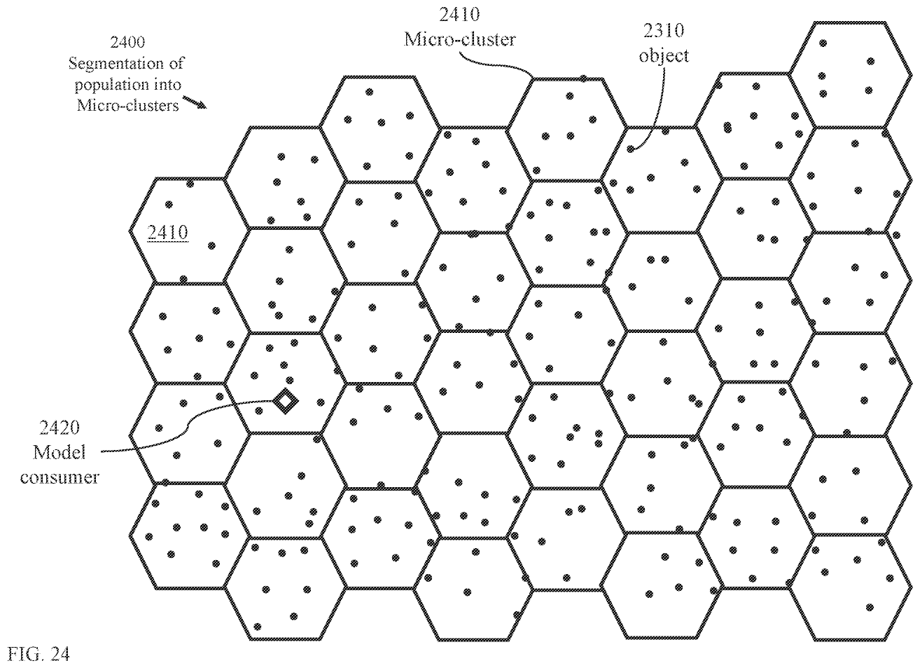

FIG. 24 illustrates a pattern 2400 of population segmentation into adjacent micro-clusters 2410. As described above, the number of clusters is determined according to the number v of variates and the numbers Sⱼ, 0≤j<v, v>1, of variate-specific strata. The total number K of cluster zones equals (S₀×S₁× . . . ×Sᵥ₋₁). Thus, with five variates (v=4) and four strata per variate, K=1024. However, if the variates are ranked according to some importance criterion, with the number of variate strata determined accordingly so that the numbers of variate strata are 4, 3, 3, 2, and 2, for example, the number of clusters is reduced to K=4×3×3×2×2=144.

If the number of variates is increased to 10 with three variate strata for each variate, the total number K of clusters becomes 3¹⁰=59049. With 20 variates (v=20) and with only two variate strata for each variate, the total number of potential clusters becomes 2²⁰=1048576, which is prohibitively large. The rapid increase of the number of potential clusters with the number of variates and the number of variate strata suggests one of three approaches.

A first approach is to:
(1) generate a large number of micro-clusters;
(2) prune the generated micro-clusters to remove each cluster having a number of objects below a predefined threshold, then distribute objects of removed micro-clusters to respective nearest micro-clusters; and
(3) identify a focal micro-cluster and neighbouring micro-clusters for a model consumer 2420.

A second approach is to:
(a) generate a large number of micro-clusters;
(b) prune the generated micro-clusters as described above;
(c) segment the micro-clusters into ordinary clusters using conventional clustering techniques; and
(d) identify a focal ordinary cluster for the model consumer 2420.

A third approach is to:
(A) selected a relatively small number of variates (dominant variates);
(B) generate a moderate number of ordinary clusters using conventional clustering techniques; and
(C) identify a focal ordinary cluster for the model consumer 2420.

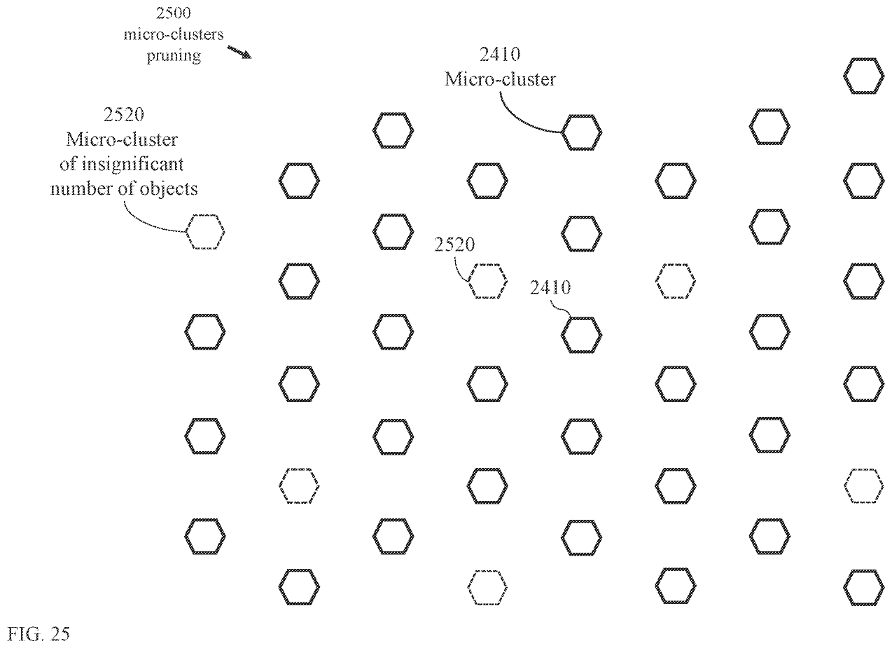

FIG. 25 illustrates a process 2500 of pruning micro clusters where micro-cluster of insignificant membership (reference 2520) are eliminated and their content redistributed as described above (first approach).

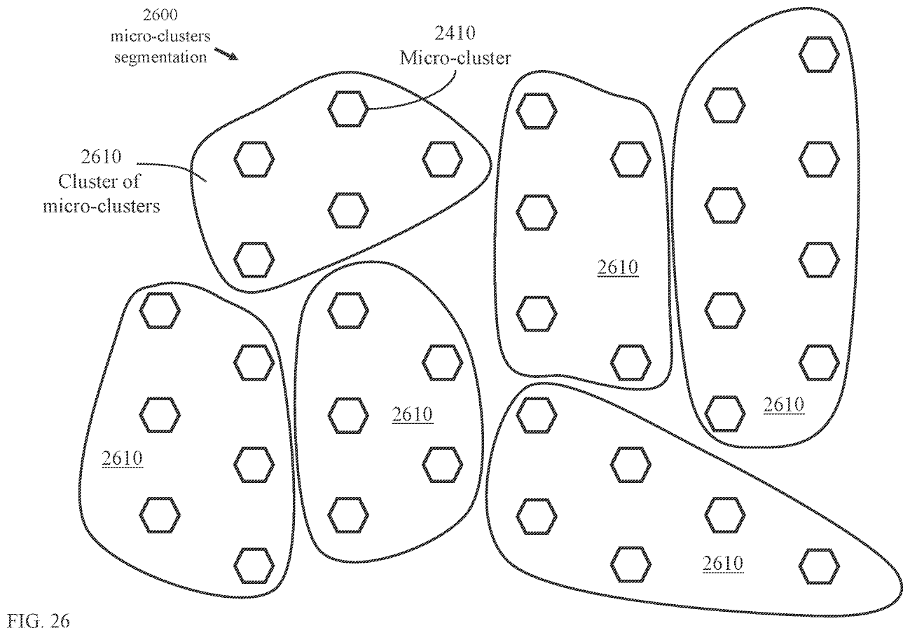

FIG. 26 illustrates a process 2600 of segmenting a plurality of micro-clusters into a plurality of ordinary clusters 2620 as described above (second approach).

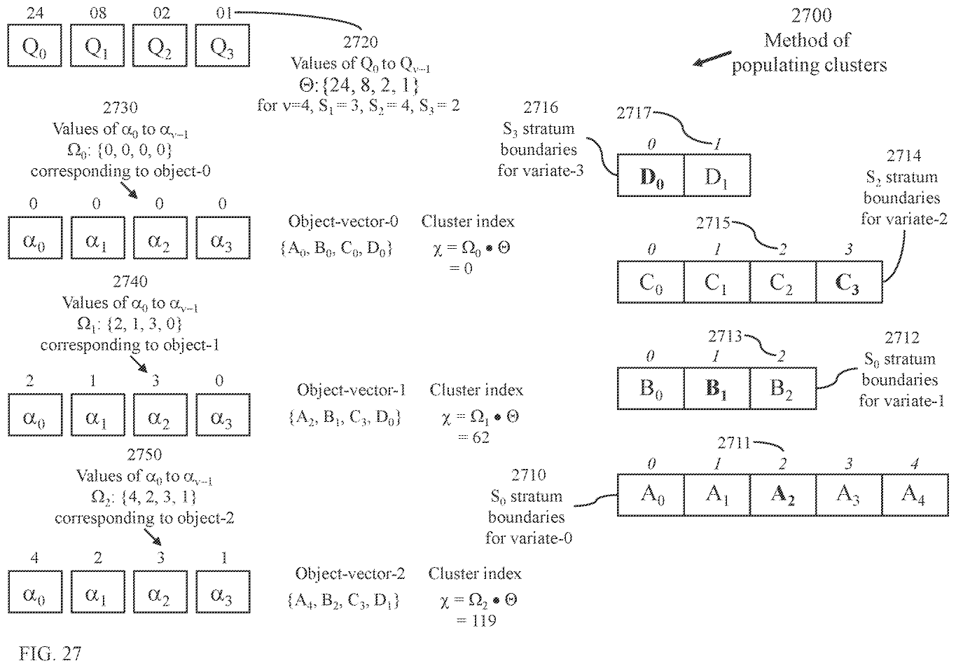

FIG. 27 illustrates a method 2700 of populating clusters for a case of four variates (v=4) denotes variate-0 to variate-3, where the numbers of variate strata are 5, 3, 4, and 2, respectively.

Stratum indices 0 o 4 (reference 2711) correspond to stratum boundaries 2710 of variate-0 (denoted A₀ to A₄). Stratum indices 0 to 2 (reference 2713) correspond to stratum boundaries 2712 of variate-1 (denoted B₀ to B₂). Stratum indices 0 to 3 (reference 2715) correspond to stratum boundaries 2714 of variate-2 (denoted C₀ to C₃). Stratum indices 0 to 1 (reference 2717) correspond to stratum boundaries 2716 of variate-2 (denoted D₀ and D₁). The cluster-indicator vector, Θ, is determined as {24, 8, 2, 1}.

The object-strata vector 2730 of a first object, denoted Ω₀, is determined as {0, 0, 0, 0}. Hence, the first object belongs to the cluster of index 0. The object-strata vector 2740 of a second object, denoted Ω₁, is determined as {2, 1, 3, 0}. The dot product of Ω₁ and Θ is 62. Hence, the second object belongs to the cluster of index 62. The object-strata vector 2750 of a third object, denoted Ω₂, is determined as {4, 2, 3, 1}. The dot product of Ω₂ and Θ is 119. Hence, the third object belongs to the cluster of index 119.

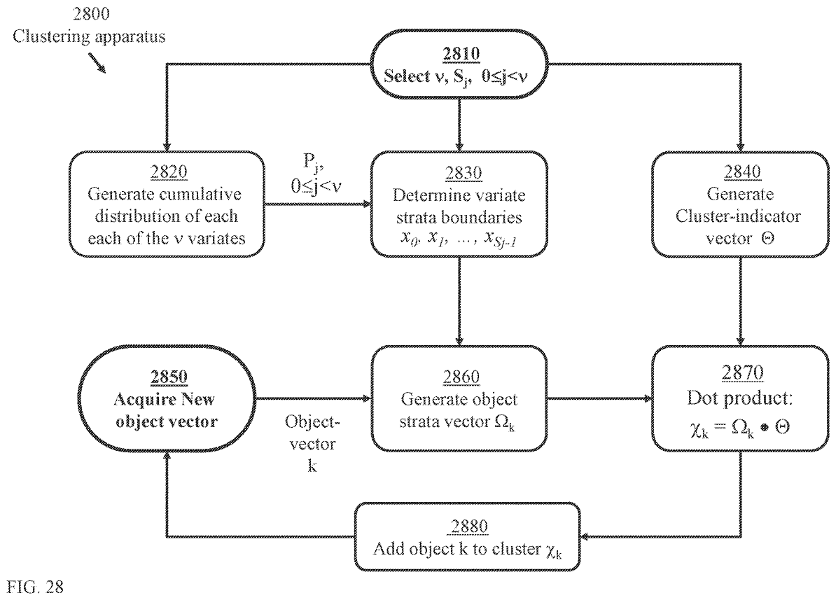

FIG. 28 illustrates an apparatus 2800 for clustering a population of objects. An information acquisition module 2810 is configured to communicate with a user of the apparatus to access a storage medium maintaining object-characteristics vectors for each object of the population of objects. Acquisition module 2810 also communicates with an administrator of the apparatus to obtain identifiers of a set of v variates, v>1, characterizing each object of the population of objects. The set of v variates is selected from a superset of predefined variates characterizing the population of objects. Additionally, the administrator specifies a number Sⱼ, 0≤j<v, of population strata for each variate of the selected set of v variates.

A module 2840 generates a cluster-indicator vector, denoted Θ, based on the number of population strata, to facilitate associating each object of the population of objects with a cluster according to individual objects' characteristics.

A module 2820 generates a cumulative distribution of each of the v variates according to the acquired object-characteristics data. The cumulative distribution may be constructed directly from the population data. Alternative, the cumulative distribution may be formed based on computing two or three moments of a variate. A module 2830 determines, for each variate, variate-strata boundaries according to a variate's number of population strata.

Apparatus 2800 periodically updates the cumulative density function for each variate and recomputes the variate-strata boundaries 2830.

A module 2850 accesses a storage medium of the population of objects under consideration to acquire object-characteristics vectors to be supplied to module 2860 which generates an object-strata vector for each selected object. The number of objects, denoted N, may be of the order of a billion, and an object-strata vector is determined for each object. A module 2860 determines for each object an object-strata vector. An object-strata vector, denoted Ωₖ, for an object of index k, 0≤k<N, translates values of the v variates of object k to corresponding strata indices of the v variates. Values x₀, x₁, . . . , xᵥ₋₁, of an object would translate to indices {α₀, α₁, . . . , αᵥ₋₁}, where 0≤α₁<Sⱼ, Sⱼ being a number of strata of a variate j, 0≤j<v.

Module 2860 determines an object-strata-vector based on an object-characteristics vector of an object and the variate-strata boundaries generated in module 2830. Module 2870 associates an object of index k (and a corresponding object-strata vector Ωₖ) with a cluster of index χ determined as the dot product of Ωₖ and the cluster-indicator vector Θ. Thus, with

Ωₖ={α₀, α₁, . . . αᵥ₋₁}, and Θ={Q₀, Q₁, . . . Qᵥ₋₁}.

χ=(α₀×Q₀+α₁×Q₁+ . . . +αᵥ₋₁×Qᵥ₋₁).

A module 2880 adds each object to a cluster-membership storage area of a respective cluster corresponding to cluster index χ. The storage area is initialized as an empty storage area.

The apparatus may further comprise: a storage medium (not illustrated in FIG. 28, compared with 140 FIG. 1) holding marketing data relating each commodity of selected commodities to characteristics of a respective model consumer; a module (not illustrated, compared with 160, FIG. 1, 470, FIG. 4) for associating each commodity with a respective cluster according to the characteristics of the respective model consumer; and a module for communicating information relevant to each commodity to members of a respective cluster.

Preferably, apparatus 2800 employs multiple processing units and modules 2850, 2860, and 2870 preferably use different processing units to concurrently acquire new object data, generate object-strata-vectors, and determine cluster indices.

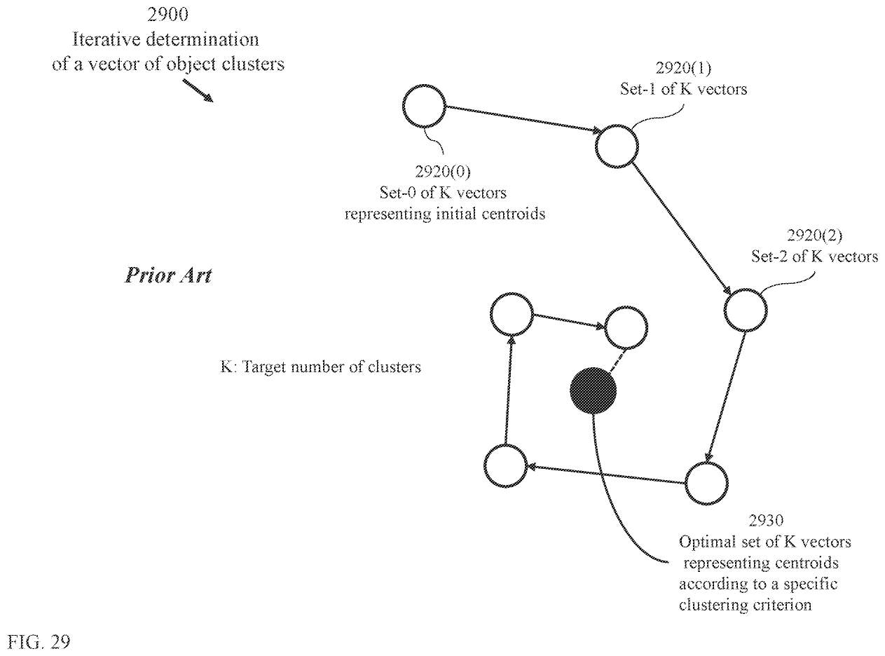

FIG. 29 illustrates a conventional iterative method 2900 of segmenting objects into a predefined number of clusters to be extended for application to segmenting micro-clusters into mini clusters. Starting with an initial set 2920(0) of K centroids, K>1, a clustering criterion is applied to determine an improved set 2920(1) of K centroids to which the clustering criterion is applied to produce a further improved set 2920(2), and so on, until a steady-state solution is reached with a cluster set 2930.

Thus, the invention provides a machine-aided marketing system comprises data-storage devices and instructions-storage devices. The data-storage devices comprise: (1) a first memory device 120 storing marketing data relating each commodity of a plurality of commodities to characteristics of a respective consumer; (2) a buffer 110 holding identifiers of selected commodities; and (3) a second storage medium 150 storing identifiers of consumers belonging to individual clusters of consumers and distinct cluster characteristics of each cluster of consumers.

The instructions-storage devices comprise processor-executable instructions organized into: (a) a first module 130 comprising instructions causing a processor to determine for each selected commodity characteristics of a respective model consumer 140 based on the marketing data; (b) a second module 160 comprising instructions causing the processor to associate each selected commodity with a respective cluster according to the characteristics of the respective model consumer and the distinct cluster characteristics; and (c) a third module 170 comprising instructions causing the processor to communicate information relevant to each commodity to members of respective associated clusters. In some implementations, the processor comprises multiple hardware processing units operating concurrently.

The invention further provides a marketing method comprising employing a first hardware processor to execute instructions for segmenting 230 a population of prospective consumers into clusters of consumers based on known characteristics of individual objects and determining distinct characteristics of each cluster. A second hardware processor executes instructions for: (a) receiving 210 an identifier of a specific commodity to promote; (b) determining 220 characteristics of a model consumer for the specific commodity using acquired marketing information; (c) determining 240 a compatible cluster for the model consumer according to the characteristics of the model consumer and the distinct characteristics of individual clusters of consumers; and (d) communicating 250 with members of the compatible cluster.

The invention further provides an apparatus 300 for machine-aided marketing comprising a memory device 310 storing object characterization data, a data-organization assembly 320, and an operational assembly 340.

The data-organization assembly 320 comprises: (1) a first hardware processor 430; (2) a module 410 for acquiring characteristics of objects of a population of objects; (3) a module 420 for segmenting the population of objects into clusters based on individual objects' characteristics and determining distinct characteristics of individual clusters; and (4) a memory device 440 storing for each cluster respective distinct characteristics and identifiers of respective objects;

The operational assembly 340 comprises: (a) a second hardware processor 450; (b) an interface 460 for receiving identifiers of specific commodities to promote; (c) a module 470 for determining characteristics of a model consumer for a specific commodity; (d) a module 480 for determining a compatible cluster for a model consumer; and (e) a module 490 for communicating with members of the compatible cluster.

The invention further provides a method of segmenting a plurality of objects into a plurality of clusters. The method comprises selecting 1820 a set of variates for characterizing individual objects and determining 1830 a respective number of population strata for each variate of the set of variates. A hardware processor is employed to execute preparatory processes and real-time operational processes. The preparatory processes compute variate boundaries defining the population strata. The operational processes, applied to each object of the plurality of objects, comprise: (a) acquiring 1860 an object vector of variate values; (b) determining 1870 a stratum index for each variate; (c) determining 1880 a cluster index of a specific cluster to which each object belongs according to the stratum index and the respective number of population strata for said each variate; and (d) allocating each object to a respective cluster accordingly.

The preparatory processes comprise: (1) determining for each variate a cumulative density function (FIG. 12, FIG. 13); (2) determining (S−1) reference cumulative-density values of j×(1.0/S), 0≤j<S, S being the respective number of population strata; and (3) determining the variate stratum boundaries to correspond to the reference cumulative-density values.

The process of determining the cluster index comprises: (a) determining for each variate a respective number of strata; (b) determining variate-specific multipliers Q₀, Q₁, . . . , Q₍ᵥ₋₁₎ using the recursion:

Q₍ᵥ₋₁₎=1, Qⱼ=S₍ⱼ₊₁₎×Q₍ⱼ₊₁₎ for (v−1)>j≥0, where v is a number of variates of the set of variates, v>1, Sⱼ is a number of strata for variate j, 0≤j<v; (c) determining stratum indices αⱼ for each variate j, 0≤j<v, according to the value of each variate of the object vector and the variate boundaries; and (d) determining 1840 the cluster index, denoted χ, as: χ=(α₀×Q₀+α₁×Q₁+ . . . +αᵥ₋₁×Qᵥ₋₁).

The invention further provides a method of machine-aided marketing comprising employing a hardware processor to execute instructions for: (1) selecting 1820 a set of variates for characterizing each object of a plurality of objects and determining 1830 a respective number of population strata for each variate of said set of variates; (2) defining boundaries of a plurality of cluster zones (FIGS. 14-16) according to the set of variates and the population strata; (3) selecting a number of variates of the set of variates and the respective number of population strata so that a total number of said cluster zones exceeds a predefined cluster-count threshold; (4) allocating each object of the plurality of objects to a cluster of a plurality of clusters corresponding to the plurality of cluster zones according to the boundaries of the cluster zones and object vectors individually characterizing said plurality of objects; (5) receiving a specific object vector of a model object; (6) identifying a focal cluster of the model object according to the specific object vector and the boundaries; and (7) communicating with objects of the focal cluster.

Optionally, prior to allocating each object to a cluster, the plurality of clusters is pruned (FIG. 25) to eliminate each cluster having a number of objects below a predefined lower bound and objects of any eliminated clusters are transferred to respective nearest clusters.

The invention further provides a method of machine-aided marketing. To start, a set of variates is selected for characterizing each object of a plurality of objects then a respective number of population strata for each variate of the set of variates is selected.

A hardware processor executes instructions to perform processes of: (a) defining boundaries of a plurality of cluster zones according to the set of variates and said population strata; (b) selecting a number of variates of the set of variates and the respective number of population strata so that a total number of said cluster zones exceeds a predefined cluster-count threshold; and (c) allocating each object of said plurality of objects to a micro-cluster of a plurality of micro-clusters corresponding to the plurality of cluster zones according to the defined boundaries and object vectors individually characterizing the plurality of objects; and (d) segmenting (FIG. 26) the plurality of micro-clusters into a predefined number of aggregate clusters.

Subsequently, upon receiving a specific object vector of a model object, the instructions cause the processor to identify a focal aggregate cluster of the model object according to the specific object vector and content of the created aggregate clusters. The instructions cause the processor to communicate with objects of the focal aggregate cluster for marketing purposes. The process of segmenting the plurality of micro-clusters may be based on any of conventional object-clustering methods. The cluster-count threshold is preferably significantly larger than the predefined number of aggregate clusters; at least twice as large.

The processes described above, as applied to a social graph of a vast population, are computationally intensive requiring the use of multiple hardware processors. A variety of processors, such as microprocessors, digital signal processors, and gate arrays, may be employed. Generally, processor-readable media are needed and may include floppy disks, hard disks, optical disks, Flash ROMS, non-volatile ROM, and RAM.

Systems of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the methods of this disclosure.

It should be noted that methods and systems of the embodiments of the invention and data described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst due the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments illustrated in the drawings and described in the specification may be made within the scope of the following claims without departing from the scope of the invention in its broader aspect.

1. An apparatus, for clustering a population of objects, comprising:
a memory device, storing computer executable instructions for execution by a processor, causing the processor to:
obtain:
identifiers of a set of variates characterizing each object of a population of objects;
a number of population strata for each variate of said set of variates; and
an object-characteristics vector for each object of the population of objects;
generate a cluster-indicator vector according to said number of population strata;
determine, for each variate, variate-strata boundaries according to a number of population strata of said each variate;
determine for said each object:
an object-strata-vector based on a respective object-characteristics vector of said each object and said variate-strata boundaries;
a cluster index as a dot product of the object-strata vector and the cluster-indicator vector;
add said each object to a cluster-membership storage area of a respective cluster corresponding to said cluster index, said storage area being initialized as an empty storage area.

2. The apparatus of claim 1 wherein said computer executable instructions further cause said processor to communicate with members of said respective cluster.

3. The apparatus of claim 1 wherein said computer executable instructions further cause said processor to determine variate-specific multipliers Q₀, Q₁, . . . , Q₍ᵥ₋₁₎ using the recursion:
Q₍ᵥ₋₁₎=1,
Qⱼ=S₍ⱼ₊₁₎×Q₍ⱼ₊₁₎, for (v−1)>j≥0,
where v is a number of variates of said set of variates, v>1, Sⱼ is a number of population strata for variate j, 0≤j<v;
said cluster-indicator vector, denoted Θ, being defined as Θ={Q₀, Q₁, . . . Q₍ᵥ₋₁₎}.

4. The apparatus of claim 3 wherein said computer executable instructions further cause said processor to:
determine for said each variate a respective cumulative density function;
determine (S−1) reference cumulative-density values of (j×1.0/S), 0≤j<S, S being said number of population strata; and
determine said variate-strata boundaries to correspond to said reference cumulative-density values.

5. The apparatus of claim 4 wherein said computer executable instructions further cause said processor to determine stratum indices αⱼ for each variate j, 0≤j<v, of said each object, based on comparing a value of each variate of said respective object-characteristics vector with said variate-strata boundaries, said object-strata vector, denoted Ωⱼ, being defined as Ωⱼ={α₀, α₁, . . . α₍ᵥ₋₁₎}.

6. The apparatus of claim 4 wherein said computer executable instructions further cause said processor to determine said respective cumulative distribution function based on computed moments for said each variate.

7. The apparatus of claim 4 wherein said computer executable instructions further cause said processor to periodically update said respective cumulative density function and said variate-strata boundaries.

8. The apparatus of claim 1 wherein said processor comprises multiple processing units and the computer executable instructions cause different processing units to concurrently determine said object-strata-vector and said cluster index.

9. A method for clustering a population of objects, comprising:
employing a hardware processor for:
obtaining:
identifiers of a set of variates characterizing each object of a population of objects;
a number of population strata for each variate of said set of variates; and
an object-characteristics vector for each object of the population of objects;
generating a cluster-indicator vector according to said number of population strata;
determining, for each variate, variate-strata boundaries according to a number of population strata of said each variate;
determining for said each object:
an object-strata-vector based on an object-characteristics vector of said each object and said variate-strata boundaries;
a cluster index as a dot product of the object-strata vector and the cluster-indicator vector;
adding said each object to a cluster-membership storage area of a respective cluster corresponding to said cluster index, to produce a plurality of clusters, said storage area being initialized as an empty storage area.

10. The method of claim 9 further comprising communicating with members of said respective cluster.

11. The method of claim 9 further comprising determining variate-specific multipliers Q₀, Q₁, . . . , Q₍ᵥ₋₁₎ using the recursion:
Q₍ᵥ₋₁₎=1,
Qⱼ=S₍ⱼ₊₁₎×Q₍ⱼ₊₁₎, for (v−1)>j≥0,
where v is a number of variates of said set of variates, v>1, Sⱼ is a number of population strata for variate j, 0≤j<v;
said cluster-indicator vector, denoted Θ, being defined as Θ={Q₀, Q₁, . . . Q₍ᵥ₋₁₎}.

12. The method of claim 11 further comprising:
determining for said each variate a respective cumulative density function;
determining (S−1) reference cumulative-density values of (j×1.0/S), 0≤j<S, S being said number of population strata; and
determining said variate-strata boundaries to correspond to said reference cumulative-density values.

13. The method of claim 12 further comprising determining stratum indices αⱼ for each variate j, 0≤j<v, of said each object, based on comparing a value of each variate of said respective object-characteristics vector with said variate-strata boundaries, said object-strata vector, denoted Ωⱼ, being defined as Ωⱼ={α₀, α₁, . . . α₍ᵥ₋₁₎}.

14. The method of claim 12 further comprising determining said respective cumulative distribution function based on computed moments for said each variate.

15. The method of claim 9 further comprising:
receiving an identifier of a specific commodity;
determining characteristics of a model consumer for the specific commodity based on acquired marketing information;
associating said specific commodity with a respective cluster according to said characteristics of said model consumer; and
communicating information relevant to said specific commodity to objects of said respective cluster.

16. The method of claim 9 further comprising
pruning said plurality of clusters to eliminate each cluster having a number of objects below a predefined lower bound;
transferring objects of eliminated cluster to respective nearest clusters.

17. The method of claim 9 further comprising ranking variates of said set of variates and selecting said number of population strata for each variate according to said ranking.

18. The method of claim 9 wherein said hardware processor comprises multiple processing units and the method further comprises using different processing units to concurrently perform said determining for said each object an object-strata-vector and said determining for said each object a cluster index.

19. An apparatus, for clustering a population of objects, comprising:
a memory device, having computer executable instructions stored thereon for execution by a processor, forming:
an information acquisition module for obtaining:
identifiers of a set of variates characterizing each object of a population of objects;
a number of population strata for each variate of said set of variates; and
an object-characteristics vector for each object of the population of objects;
a module for generating a cluster-indicator vector according to said number of population strata;
a module for determining, for each variate, variate-strata boundaries according to a number of population strata of said each variate;
a module for determining for said each object:
an object-strata-vector based on an object-characteristics vector of said each object and said variate-strata boundaries;
a cluster index as a dot product of the object-strata vector and the cluster-indicator vector;
a module for adding said each object to a cluster-membership storage area of a respective cluster corresponding to said cluster index, said storage area being initialized as an empty storage area.

20. The apparatus of claim 19 further comprising:
a storage medium storing marketing data relating each commodity of selected commodities to characteristics of a respective model consumer;
a module for associating each said each commodity with a respective cluster according to said characteristics of said respective model consumer;
a module for communicating information relevant to said each commodity to members of said respective cluster.
